(19) United States
(12) Patent Application Publication
(10) Pub. No.: US 2026/0012811 A1
(43) Pub. Date: Jan. 8, 2026

(54) METHODS, ARCHITECTURES, APPARATUSES AND SYSTEMS FOR UNLICENSED SPECTRUM OPERATIONS WITH MASSIVELY DISTRIBUTED MIMO

(71) Applicant: InterDigital Patent Holdings, Inc., Wilmington, DE (US)

(72) Inventors: Kyle Pan, Saint James, NY (US); Guodong Zhang, Woodbury, NY (US); Arman Shojaeifard, London (GB)

(21) Appl. No.: 19/100,833

(22) PCT Filed: Aug. 2, 2023
(86) PCT No.: PCT/US2023/029278

§ 371 Date: Feb. 3, 2025

Related U.S. Application Data
(60) Provisional application No. 63/394,712, filed on Aug. 3, 2022.

(51) Int. Cl. H04W 16/28; H04L 5/00; H04W 74/0808

(52) U.S. Cl. CPC H04W 16/28; H04L 5/0044; H04L 5/0053; H04W 74/0808

(57) ABSTRACT

Procedures, methods, architectures, apparatuses, systems, devices, and computer program products for unlicensed spectrum operations in massively distributed MIMO. A wireless transmit-receive unit, WTRU, may perform adaptive unlicensed operation and procedure for massively distributed MIMO. The WTRU may be (pre-)configured with information about multiple TRPs/TCIs for unlicensed spectrum operations. The WTRU may determine a degree of channel uncertainty. The WTRU may determine a TRP-TCI group and a TRP-TCI set within the determined TRP-TCI group, and may report to the network LBT status for the determined TRP-TCI set. Following the reporting, the WTRU may receive an indication of scheduling resources for the determined TRP-TCI set, and may receive PDSCH or PUSCH transmission according to the indicated scheduling resources.

### CROSS-REFERENCE TO RELATED APPLICATIONS

This application claims the benefit of U.S. Provisional Patent Application No. 63/394,712 filed 03 Aug, 2022, which is incorporated herein by reference.

### FIELD

The present disclosure is generally directed to the fields of communications, software and encoding, including, for example, to methods, architectures, apparatuses, systems directed to unlicensed spectrum operations.

### BACKGROUND

The present disclosure is generally directed to the fields of communications, software and encoding, including, for example, to methods, architectures, apparatuses, systems directed to unlicensed spectrum operations with massively distributed Multiple Input Multiple Output (MIMO).

### SUMMARY

There are disclosed embodiments of methods, as described in the following and as claimed in the appended claims.

There are disclosed embodiments of a wireless transmit-receive unit, WTRU, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an embodiment of a method of massive TRP operations;

FIG. 3 is an embodiment of a method of massive TRP diversity transmission to cope with channel uncertainty;

FIG. 4 depicts an embodiment of a massive TRP operation indicator table (Table 1), an embodiment of a massive TRP operation indicator table using CORESETPoolIndex (Table 2), and an embodiment of a massive TCI operation indicator table (Table 3);

FIG. 5 depicts an embodiment of a massive TCI operation indicator table (joint) (Table 4) and an embodiment of a massive LBT operation indicator table (Table 5);

FIG. 6 depicts an embodiment of a massive LBT operation with interference indicator table (Table 6) and an embodiment of a massive TRP LBT operation indicator table (Table 7);

FIG. 7 is a flow chart of an embodiment of a method of adaptive LBT mode operations;

FIG. 8 is a flow chart of another embodiment of a method of adaptive LBT mode operations;

FIG. 9 is an embodiment of a massive LBT operation mode 1 table (Table 8), and an embodiment of a massive LBT operation mode 2 table (Table 9);

FIG. 10 is an embodiment of a massive TRP indicator table (Table 10), an embodiment of a massive TRP indicator using CORESETPoolIndex table (Table 11), an embodiment of a hierarchical TRP group (TRPG) indicator table (Table 12) and an embodiment of a hierarchical TRP indicator in TRP group table (Table 13);

FIG. 11 is an embodiment of a hierarchical CORESET pool group (CORESETPoolGRP) indicator table (Table 14), and an embodiment of a hierarchical CORESET pool indicator in CORESET pool group (CORESETPoolGRP) table (Table 15);

FIG. 12 is a flow chart of an embodiment of a method of adaptive TRP/TCI operations;

FIG. 13 is a flow chart of an embodiment of a method of TDRA mode operations (indication);

FIG. 14 is a flow chart of an embodiment of a method of TDRA mode operations (activation);

FIG. 15 is a flow chart of an embodiment of a method of TDRA mode operations (indication/activation);

FIG. 16 is an embodiment of a massive MBT operation RB set 1 table (Table 16), and an embodiment of a massive LBT operation RB set 2 table (Table 17);

FIG. 17 is an embodiment of a massive availability indication RB set 1 table (Table 18), and an embodiment of a massive availability indication RB set 2 table (Table 19);

FIG. 18 is an embodiment of a massive LBT confirmation RB set 1 table (Table 20), and an embodiment of a massive LBT confirmation RB set 2 table (Table 21);

FIG. 19 is a sequence chart of an embodiment of a method of adaptive unlicensed spectrum operations;

FIG. 20 is a flow chart of an embodiment of a method of adaptive LBT mode operations;

FIG. 21 is a flow chart of another embodiment of a method of adaptive LBT mode operations;

FIG. 22 is a flow chart of an embodiment of a method of efficient adaptive unlicensed spectrum operations for massively distributed MIMO with massive number of TRPs;

FIG. 23 is a flow chart of an embodiment of a method of efficient adaptive unlicensed spectrum operations for massively distributed MIMO with massive number of TRPs and beams;

FIG. 24 is a flow chart of another embodiment of a method of efficient adaptive unlicensed spectrum operations for massively distributed MIMO with massive number of TRPs and beams;

FIG. 25 is a flow chart of yet another embodiment of a method of efficient adaptive unlicensed spectrum operations for massively distributed MIMO with massive number of TRPs and beams;

FIG. 26 is a flow chart of a method implemented by a WTRU in a network according to an embodiment;

FIG. 27 is a flow chart of a method implemented by a WTRU in a network according to an embodiment; and

FIG. 28 is a flow chart of a method implemented by a WTRU in a network according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Abbreviations and Acronyms

CORESET Control Resource Set

MIMO Multiple Input Multiple Output

UE User Equipment, see WTRU

WTRU Wireless Transmit-Receive Unit, see UE

### Example Communications System

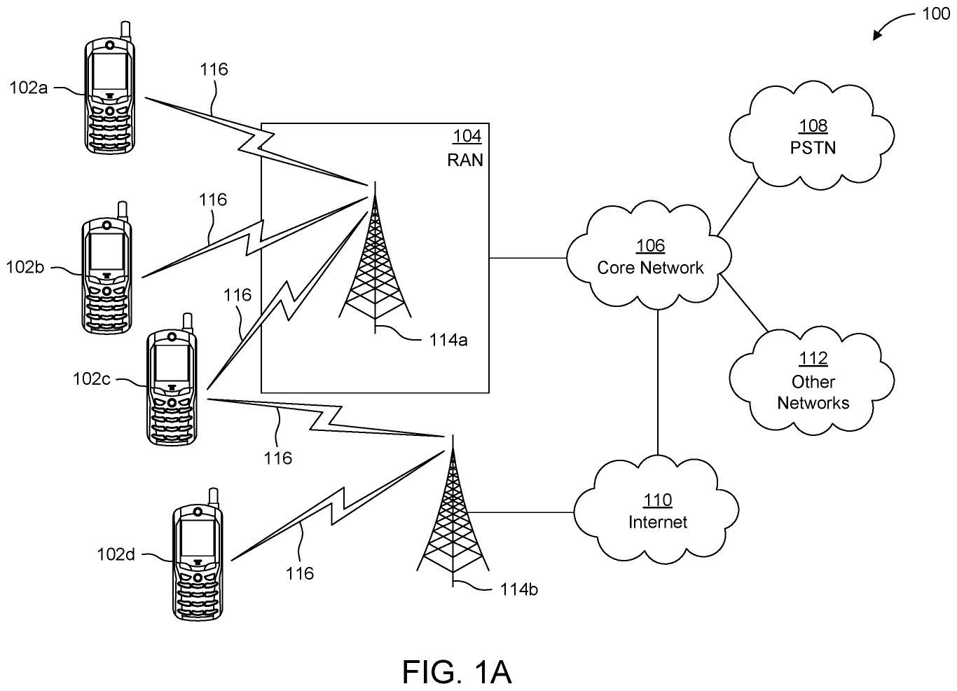

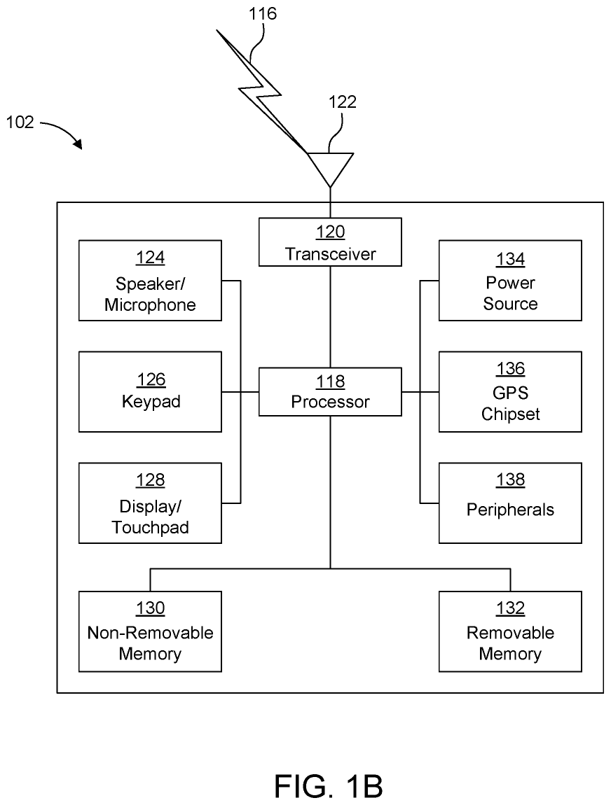

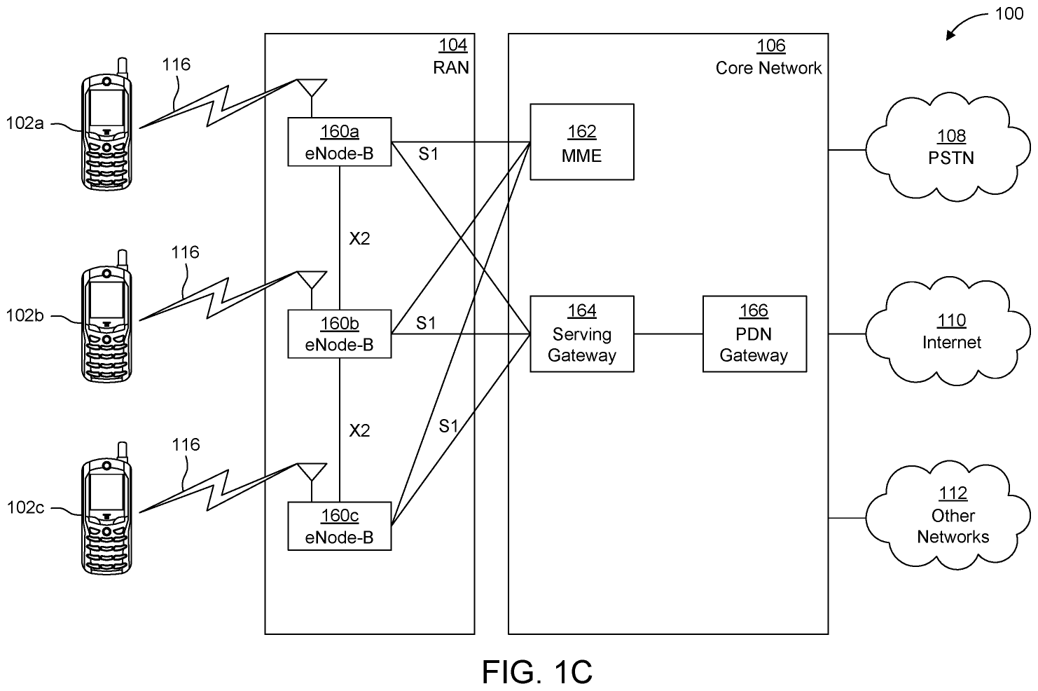

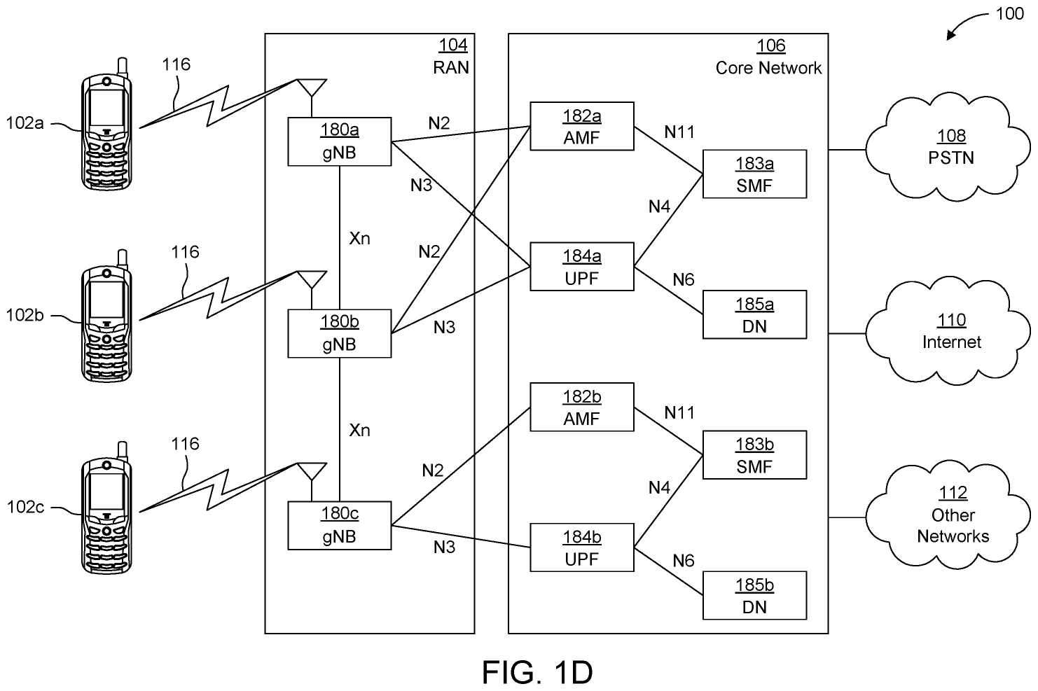

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception))

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

Methods of unlicensed spectrum operation and transmission configuration indication (TCI) are disclosed for massively distributed MIMO and massive Transmission and Reception Points (TRPs). According to an embodiment, a WTRU may perform adaptive operation and procedure for unlicensed massively distributed MIMO (MD-MIMO). The WTRU may be configured for multiple sets/modes, e.g., for TRPs/TCIs, resources, Time Domain Resource Allocation (TDRA) tables (for MD-MIMO unlicensed spectrum operations).

In the following, high and low, small and large, fast and slow, as for example low or high channel uncertainty, fast or slow evolving channel conditions, small or large sets, are relative to a threshold value or range. For example, a threshold may be defined at x, and channel uncertainty that is lower than x is considered low channel uncertainty, and a channel uncertainty that is higher than x is considered high channel uncertainty. x may be included or excluded, for example a low channel uncertainty may be represented by values lower than x while including x, or lower than x while excluding x, while a high channel uncertainty may be represented by values that are higher than x, including x or excluding x. x may be an absolute value, such as 1, 100,-250.345 or 0, or a range of values such as 1-5, 100-200,-250.345 to-215.100. x may be preset, preconfigured, or received as configuration information.

In the following, for example, if the delta of measured interference within a configured time window or period is higher than a threshold, then channel condition is determined to be changing fast, otherwise if the delta of measured interference within a configured time window or period is not higher than a threshold, then channel is determined to be not changing fast, or the like. The same applies for other type of parameters, such as the above discussed channel uncertainty.

The WTRU may perform the following:
receive indication for availability of resources for TRP/TCI states, Resource Blocks (RBs), etc.;
use indicated set of TRPs/TCIs, e.g., large TRP/TCI set for high channel uncertainty and small TRP/TCI set for low channel uncertainty;
if LBT status report is enabled, report Listen-Before-Talk (LBT) status on the indicated set of TRPs/TCIs and receive scheduling information for resources for TRP/TCI states, RBs, etc.; or,
if LBT status report is not enabled or disabled, use previous indicated resource as scheduling resources for TRPs/TCI states;
receive scheduling information for resources for RBs;
if TDRA mode with activation/indication is enabled or indicated, use indicated TDRA table in activated subset of TDRA tables; or
if TDRA mode with indication is enabled or indicated, use indicated TDRA table in (pre) configured set of TDRA tables;
in case of downlink, receive Physical Downlink Shared Channel (PDSCH) using scheduling information e.g., TRP(s)/TCI state(s), RBs, TDRA, etc.; or
in case of uplink, transmit (Physical Uplink Shared Channel) PUSCH using scheduling information e.g., TRP(s)/TCI state(s), RBs, TDRA, etc.

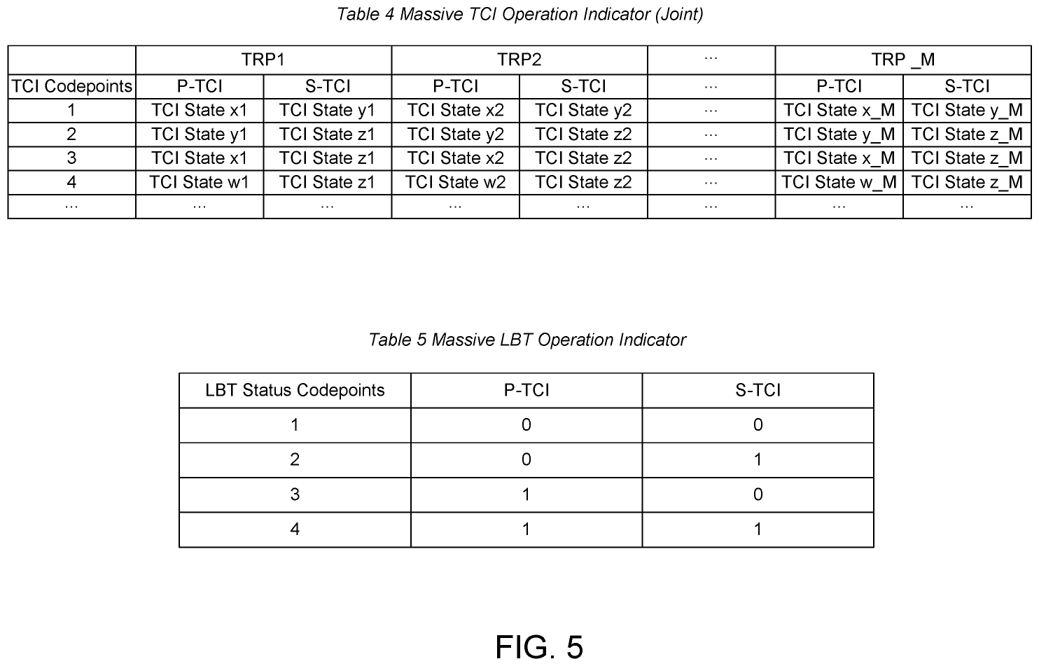

According to another embodiment, a WTRU may perform adaptive unlicensed operation and procedure for massively distributed MIMO. The WTRU may be (pre-)configured with multiple TRPs/TCIs (for unlicensed spectrum operations). The WTRU may perform the following:
receive indication for which TRPs/TCI states to use, and:
determine the degree of channel uncertainty, e.g., the channel uncertainty may be determined based on e.g., NACK-to-ACK ratio, LBT failure, or the like, and
if channel uncertainty is determined to be high, report LBT status using one of codepoints for LBT status (e.g., see FIG. 5, Table 5, the ‘codepoint’ may be 1, 2, 3 or 4 pointing to the states of P-TCI and S-TCI, as such, the ‘codepoint’ may be a ‘table index’ or ‘codepoint index’ or ‘index’); receive further indication for which TRPs/TCIs to use, or
if channel uncertainty is determined to be low, not report LBT status. Use all indicated TRPs/TCI states;
receive PDSCH or transmit PUSCH using the indicated TRPs/TCIs.

According to yet another embodiment, the WTRU may perform adaptive unlicensed operation and procedure for massively distributed MIMO. The WTRU may be (pre-) configured with multiple TRPs/TCIs (for unlicensed spectrum operations). The WTRU may perform the following:
receive indication for which TRPs/TCI states to use;
determine the degree of channel uncertainty, e.g., the channel uncertainty may be determined based on e.g., NACK-to-ACK ratio, LBT failure, or the like, and report channel uncertainty to gNB.
if channel uncertainty is determined to be high, receive indication to use large set of TRPs/TCI state; or,
if channel uncertainty is determined to be low, receive indication to use small set of TRPs/TCI state;
receive indication to use TRPs/TCI states in the determined set of TRPs/TCIs;
receive PDSCH or transmit PUSCH using the indicated TRPs/TCIs.

According to yet another embodiment, a WTRU may perform adaptive unlicensed operation and procedure for massively distributed MIMO. The WTRU may be (pre-) configured with multiple TRPs/TCIs (for unlicensed spectrum operations). The WTRU may perform the following:
receive TCI configurations;
receive indication for availability of resources for TRPs/TCI states, RBs, etc.;
report LBT status with or without interference level using LBT status codepoints;
receive scheduling information for resources for TRPs/TCI states, RBs, TDRA, etc.;
receive PDSCH if downlink or transmit PUSCH if uplink using scheduling information e.g., TRP(s)/TCI state(s), RBs, TDRA, etc.

### Overview

In 5G NR, the Transmission Configuration Indication (TCI) framework has been introduced. In NR Rel-17 or before, unified TCI for single Transmission and Reception Point (TRP) is supported. For non-unified TCI, only up to two TRP operations are supports and there is no support of coherent joint transmission among TRPs. Only up to two TCI states indication with one TCI code point are supported. Only frequency range for FR1 and FR2 are supported.

For Multi-TRP operation, NR Rel-15 supports dynamic TRP selection. It also supports mobility measurements for multi-beam/multi-TRP deployments up to 64 SSBs per cell. In Rel-16, multi-TRP transmission of PDSCH for eMBB is supported. In addition, multi-TRP diversity for URLLC is supported. Multi-TRP operation is based on two TRPs. In Rel-17, Inter-cell multi-TRP operation is supported. Rel-17 introduced inter-cell multi-TPR operation without handover. Multi-TRP repetition of PDCCH, PUCCH and PUSCH is supported.

CSI-RS framework is introduced in 5G NR. Rel-15 supports CSI interference measurement based on (Zero-Power) ZP-CSI-RS (e.g., CSI-IM resources) and/or (Non-Zero-Power) NZP-CSI-RS resources and Type-II codebook for high-resolution CSI feedback. Rel-16 supports enhancement on Type-II codebook. Rel-17 supports CSI enhancement for multi-TRP non-coherent joint transmission (NCJT). Further enhancement on Type-II codebook is also supported.

In order to support wide range of services, 5G NR system aims to be flexible enough to meet the connectivity requirements of a range of existing and future (as yet unknown) services to be deployable in an efficient manner. In particular, NR considers supporting potential use of frequency range up to 100 GHz.

NR specifications that have been developed in Rel-15 and Rel-16 define operation for frequencies up to 52.6 GHz, where all physical layer channels, signals, procedures, and protocols are designed to be optimized for uses under 52.6 GHz.

However, frequencies above 52.6 GHz are faced with more difficult challenges, such as higher phase noise, larger propagation loss due to high atmospheric absorption, lower power amplifier efficiency, and strong power spectral density regulatory requirements in unlicensed bands, compared to lower frequency bands. Additionally, the frequency ranges above 52.6 GHz potentially contain larger spectrum allocations and larger bandwidths that are not available for bands lower than 52.6 GHz.

As an initial effort to enable and optimize 3GPP NR system for operation in above 52.6 GHz, 3GPP RAN has studied requirements for NR beyond 52.6 GHz up to 114.25 GHz including global spectrum availability and regulatory requirements (including channelization and licensing regimes), potential use cases and deployment scenarios, and NR system design requirements and considerations on top of regulatory requirements. The potential use cases identified in the study include high data rate eMBB, mobile data offloading, short range high-data rate D2D communications, broadband distribution networks, integrated access backhaul (IAB), factory automation, industrial IoT (IIoT), wireless display transfer, augmented reality (AR)/virtual reality (VR) wearables, intelligent transport systems (ITS) and V2X, data center inter-rack connectivity, smart grid automation, private networks, and support of high positioning accuracy. The use cases span over several deployment scenarios identified in the study. The deployment scenarios include, but not limited to, indoor hotspot, dense urban, urban micro, urban macro, rural, factor hall, and indoor D2D scenarios. The study also identified several system design requirements around waveform, MIMO operation, device power consumption, channelization, bandwidth, range, availability, connectivity, spectrum regime considerations, and others.

Among the frequencies of interest, frequencies between 52.6 GHz and 71 GHz are especially interesting relatively in the short term because of their proximity to sub-52.6 GHz for which the current NR system is optimized and the imminent commercial opportunities for high data rate communications, e.g., unlicensed spectrum but also licensed spectrum between 57 GHz and 71 GHz.

NR Rel-15 defined two frequency ranges for operation:
FR1 spanning from 410 MHz to 7.125 GHz; and
FR2 spanning from 24.25 GHz to 52.6 GHz.

The proximity of this frequency range (57-71 GHz) to FR2 and the imminent commercial opportunities for high data rate communications makes it compelling for 3GPP to address NR operation in this frequency regime. In order to minimize the specification burden and maximize the leverage of FR2 based implementations, 3GPP has decided to extend FR2 operation up to 71 GHz with the adoption of one or more new numerologies (i.e., larger subcarrier spacings). That or those new numerologies will be identified by the study on waveform for NR>52.6 GHz. NR-U defined procedures for operation in unlicensed spectrum will also be leveraged towards operation in the unlicensed 60 GHz band. NR operation may support up to 71 GHz considering, both, licensed and unlicensed operation, Similar to regular NR and NR-U operations below 52.6 GHz, NR/NR-U operation in the 52.6 GHz to 71 GHz can be in stand-alone or aggregated via CA or DC with an anchor carrier.

In Release-16 New Radio Unlicensed (NR-U), the supported numerology (i.e., SCS) can be set as 15, 30 and 60 KHz. respectively. The listen before talk (LBT) bandwidth is set to 20 MHz in Release-16 NR-U. Based on the minimum LBT bandwidth must be supported, the DL initial BandWidth Part (BWP) is nominally 20 MHz for Rel-16 NR-U. The maximum supported channel bandwidth is set to 100 MHz. The WTRU channel bandwidth (or an activated BWP) can be set as an integer multiple of LBT bandwidth (i.e., 20 MHz). For instance, for SCS=30 KHz, the total allocated PRB numbers for 20 MHz, 40 MHz and 80 MHz bandwidth is equal to 48, 102,and 214, respectively.

Due to WTRU mobility, a WTRU may move across multiple TRPs and/or multiple beams and may connect to multiple TRPs at the same time. Each TRP may employ ultra massive MIMO which could form massive number of beams. In unlicensed spectrum, channel uncertainty is present. Listen before talk (LBT) needs to be performed before the channel can be accessed. If channel is busy or not available, the WTRU and/or TRP may not be able to access the channel and perform the transmission. Methods of efficient unlicensed operations for massive TRPs and beams are required to support massively distributed MIMO deployment in unlicensed spectrum. How to accommodate all necessary TCI information and cope with channel uncertainty in unlicensed spectrum for massive TRPs and beams, minimize signaling overhead and enhance performance should be considered.

### Representative Example of Methods of Data Transmission and Reception for Unlicensed Massively Distributed MIMO

In a highly dense network, a WTRU may connect with massive TRPs in massively distributed MIMO scenarios. A WTRU may receive data via DL data channel e.g., PDSCH from massive TRPs, or may transmit data via UL data channel e.g., PUSCH to massive TRPs. Such transmission or reception may be either coherent or non-coherent. WTRU may first receive downlink control information (DCI) via DL control channel e.g., PDCCH from one or more TRPs.

When a DCI is transmitted from a single TRP to enable data reception from or transmission to massive TRPs, DCI payload size may be large if additional bits are needed in DCI to support large number of TRPs, for instance duplicated fields (e.g., TCI fields) or field extensions (e.g., for supporting a larger number of TCI codepoints). As number of TRPs increases, so does DCI payload size. Increased DCI payload size may decrease performance of PDCCH and reduce coverage of DCI. In massively distributed MIMO deployment, single DCI scheme may require additional bits to support large number of TRPs. Multi-DCI scheme may require additional PDCCHs to support large number of TRPs. Trade off between single DCI and multi-DCI schemes may be considered.

In unlicensed spectrum, channel uncertainty may be present. Data transmission from some TRPs may not be possible due to LBT failure. In addition, data reception from some TRPs may not be reliable due to interference e.g., interference caused by hidden node(s).

One solution, according to an embodiment, may be to transmit data from all possible TRPs. WTRU may receive data from some TRPs in some beams or spatial directions where interference is not present or minimal. WTRU may not receive data from other TRPs in some beams or spatial directions where interference is present or maximal. In this way, WTRU may still successfully decode data e.g., PDSCH due to diversity transmission.

Another solution, according to an embodiment, may be to report LBT status back to gNB. gNB may send an indicator to indicate the TRPs/beams for WTRU to receive PDSCH. WTRU may report LBT status back to gNB to indicate which TRPs/beams are in good conditions for WTRU to receive PDSCH. Then gNB may transmit PDSCH based on WTRU's indication. In this way, PDSCH may not be transmitted or repeated in TRPs which may not have good conditions for WTRU to receive PDSCH. This could avoid redundant PDSCH transmission. The method requires to report LBT status to gNB from WTRU.

The WTRU may perform energy detection or the like to obtain LBT status. For example, if measured energy is above a (pre-)configured threshold, then LBT status may be “fail”. If measured energy is not above or below a (pre-)configured threshold, then LBT status may be “success”. Alternatively, WTRU may perform LBT. If LBT fails or does not pass, then LBT status may be “fail”. Otherwise, if LBT succeeds or passes, then LBT status may be “success”. As an example, in case that LBT status is “success”, an “1” may be indicated. In case that LBT status is “fail”, an “0” may be indicated. WTRU, TRP, gNB or any combination of them may perform energy detection or the like to obtain LBT status.

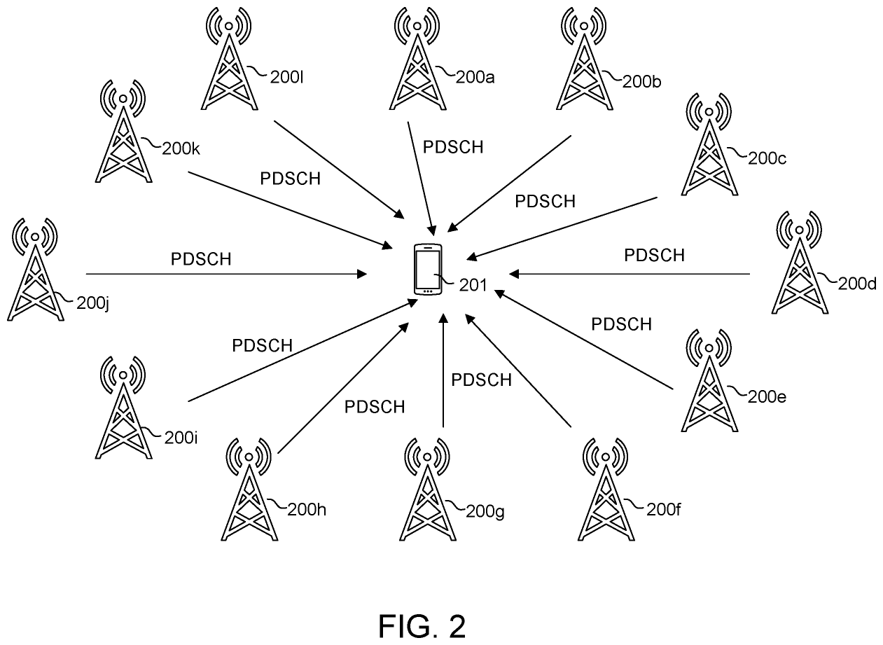

An embodiment of a method of massive TRP operations is depicted in FIG. 2. Device 200 is a WTRU. Devices 200a-l are TRPs. Arrows indicate that WTRU 201 receives/receives reliably PDSCH from the respective TRP.

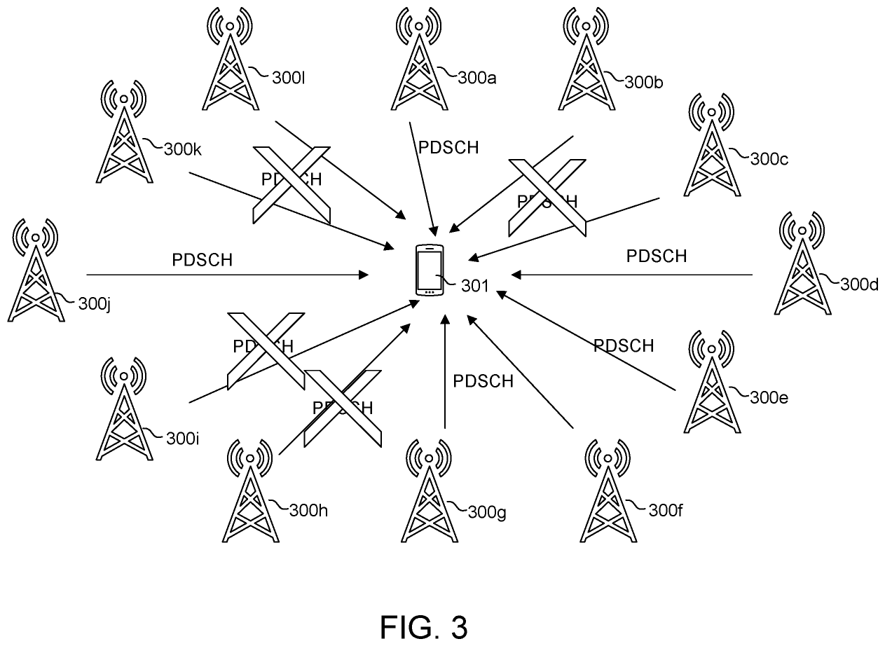

An embodiment of a method of massive TRP diversity transmission to cope with channel uncertainty is depicted in FIG. 3. In this embodiment, PDSCHs from some of TRPs (300k, 300c, 300h, 300i) may not be received or not received reliably at WTRU 301, while PDSCH is correctly received/received reliably from other TRPs (300a-b, 300d-g, 300j, 300l).

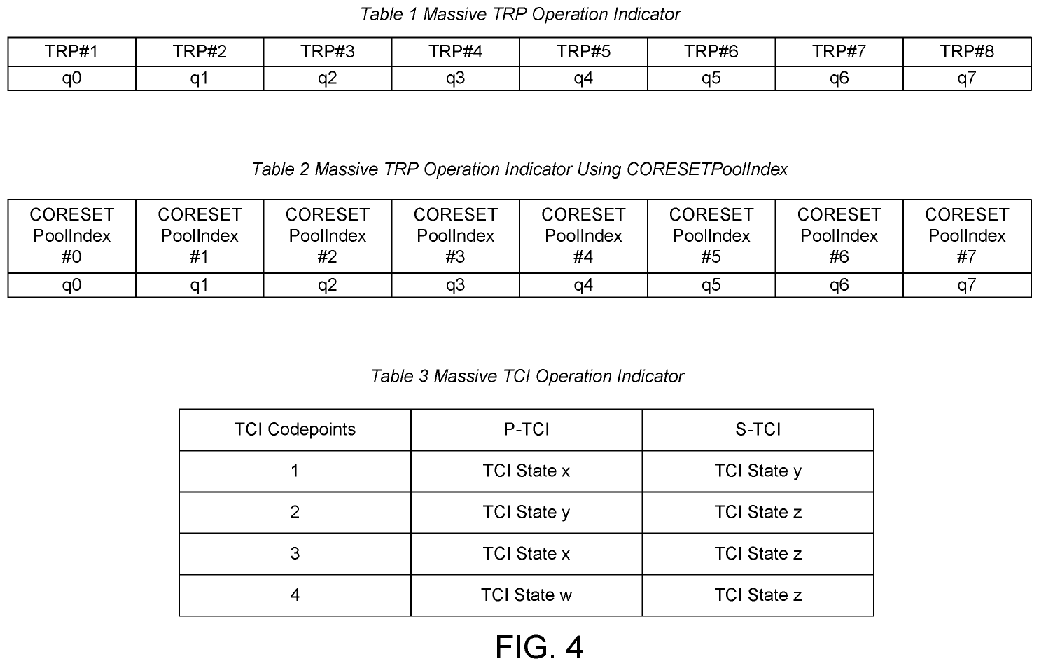

An example method of massive TRP operation indication is shown in FIG. 4, Table 1. The example shows 8 TRPs (TRP#1-#8). The WTRU may report LBT status for TRPs from which the WTRU may receive PDSCH/may reliably receive (e.g. If q_i=“1”, it implies that LBT passes (is successful) at WTRU for the i-th TRP, if q_i=“0”, it implies that LBT does not pass (is not successful) at the WTRU for the i-th TRP.

According to an embodiment, the method may be extended to massive TRPs with number of TRPs larger than 8, for example, 12 TRPs, 16 TRPs, 32 TRPs, 64 TRPs or even larger.

An example method of massive TRP operation indication using CORESETPoolIndex is shown in FIG. 4, Table 2. The example shows 8 TRPs. WTRU may report LBT status for TRPs or CORESET pools from which WTRU may receive PDCCH and/or PDSCH. If q_i=“1”, it implies that LBT passes at WTRU for the i-th TRP or CORESET pool, if q_i=“0”, it implies that LBT does not pass at WTRU for the i-th TRP or CORESET pool.

The method may be extended to massive TRPs with number of TRPs much larger than 8 for example 16 TRPs, 32 TRPs, 64 TRPs or larger.

TCI may indicate the same spatial filter as source reference signal (RS) for the target RS, signal or channel that may be QCL-ed with source RS. QCL could be referred to QCL type D. For PDSCH reception, TCI can indicate the spatial filter (or beam) for QCL type D. gNB may indicate TCI state for WTRU for receiving PDSCH.

In unlicensed band, to cope with channel uncertainty, one solution, according to an embodiment, may be that gNB may indicate a set of TCI states to each WTRU. If one TCI state is not good for WTRU due to LBT failure, Rx WTRU could try another TCI to receive PDSCH. In ultra massive MIMO, a set of TCI states may be indicated. A set of TCI states may contain primary TCI state (P-TCI) and secondary TCI state (S-TCI).

An embodiment of a massive TCI operation codepoint indicator is depicted in FIG. 4, Table 3. In this embodiment, primary TCI may contain TCI states x, y, z, w. Similarly, secondary TCI may also contain TCI states x, y, z, W.

For massive number of TRPs, each TRP may have a TCI codepoint table like FIG. 4, Table 3. Alternatively, a joint TCI codepoint table may be used as shown in FIG. 5, Table 4. Primary TCI may contain TCI states x_i, y_i, z_i, w_i for the TRP#i, where i=1, 2, . . . , M. Similarly, secondary TCI may also contain TCI states x_i, y_i, z_i, w_i for the TRP#i, where i=1, 2, . . . , M. M is the number of TRPs or CORESET pools. M may be large for massively distributed MIMO with massive number of TRPs deployment. A codepoint table may be a table containing multiple codepoints. Each codepoint may be an entry index pointing to one of the entries in the table. Codepoint table may be transmitted to WTRU via MAC CE (or RRC signaling). The codepoint (or entry index) in the table may be transmitted to WTRU via DCI in PDCCH (or MAC CE). Which TRP may transmit codepoint in DCI may depend on DCI scheme. In case of single DCI scheme, only one TRP may transmit. In case of multi-DCI scheme, multiple TRPs may transmit. TCI codepoint may be TCI control information, LBT status codepoint may be LBT status control information.

In another solution, according to an embodiment, in unlicensed band, to cope with channel uncertainty, gNB may indicate available TCI states and WTRU may indicate the LBT status of TCI states to gNB. In this example only two TCI states are considered. In general it could be extended to more than two TCI states. If primary TCI state (P-TCI) is not in good condition for WTRU to receive PDSCH due to LBT failure, WTRU could indicate status of TCI states to gNB using LBT status codepoint.

WTRU could report LBT status and/or channel uncertainty to enable more efficient transmission from gNB. In this way, unnecessary PDSCH transmission and/or repetition can be avoided or mitigated. The solution could be used to cope with hidden node issue.

An example massive TCI operation codepoint indicator is depicted in FIG. 5, Table 5.

In this example, WTRU may report LBT status to gNB for primary TCI and secondary TCI. If both primary TCI and secondary TCI are not in good condition, WTRU may report codepoint 1 for LBT status. If both primary TCI and secondary TCI are in good condition, WTRU may report codepoint 4 for LBT status.

If one of primary TCI and secondary TCI is in good condition but the other one is not in good condition, WTRU may report codepoint 2 or 3 for LBT status depending on which TCI (primary TCI or secondary TCI) is not in good condition.

A good condition may be referred to as that the measured energy is below a (pre-)configured threshold or LBT succeeds. A “not in good condition” may be referred to as that the measured energy is not below a (pre-)configured threshold or above a (pre-)configured threshold or LBT fails.

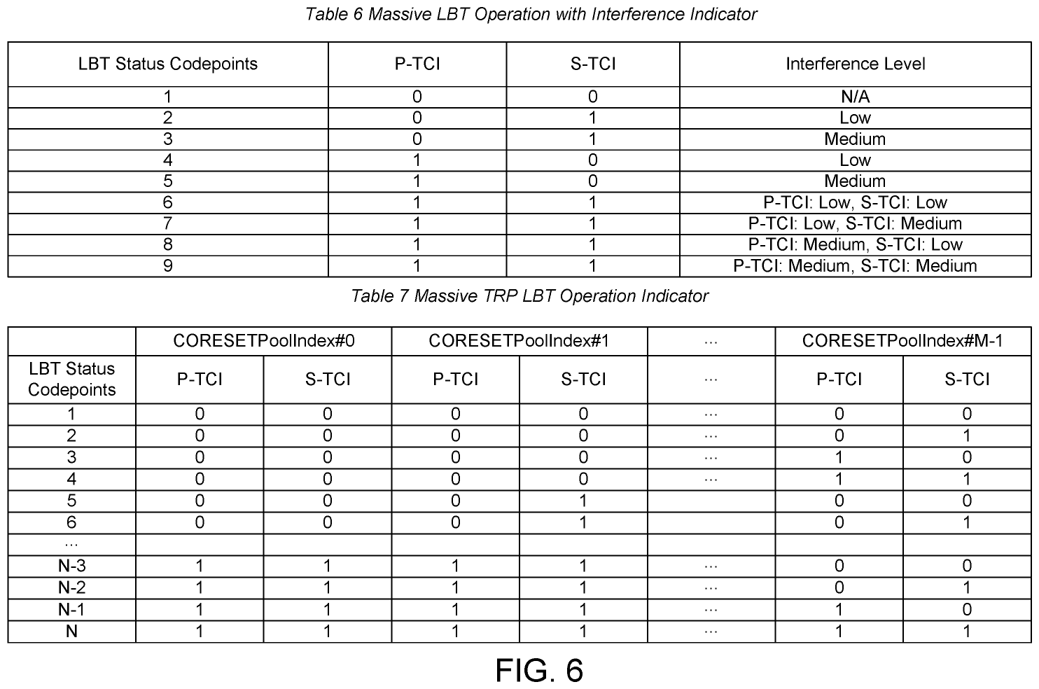

To further optimize the system operation, WTRU may also report interference level. Massive LBT operation with interference indicator is shown in FIG. 6, Table 6. In this example, WTRU may report LBT status together with interference level to gNB for primary TCI and secondary TCI.

If both primary TCI and secondary TCI are not in good condition, WTRU may only report LBT status and not report interference level (codepoint 1). If both primary TCI and secondary TCI are in good condition, WTRU may report LBT status and interference level for primary TCI and secondary TCI. The interference level may be low or medium depending on the measurement. In this case, WTRU may report codepoints 6, 7, 8 or 9 accordingly depending on LBT status and interference level.

If one of primary TCI and secondary TCI is in good condition but the other one is not in good condition, WTRU may report LBT status for primary TCI and secondary TCI and interference level for TCI (either primary TCI or secondary TCI) which is in good condition. WTRU may report codepoints 2, 3, 4 or 5 accordingly depending on LBT status and interference level.

In massively distributed MIMO with massive TRPs, gNB may indicate multiple TRPs for WTRU to receive PDSCH. This could create more opportunities to receive PDSCH. The method could cope with hidden node issue. In addition, gNB may indicate a set of TCI states for each TRP to each WTRU. If one TRP or TCI state is not in good condition for WTRU to receive PDSCH e.g., due to LBT failure, WTRU could try another TRP or TCI to receive PDSCH.

A group of TRPs and a set of TCI states may be utilized. A group of TRPs and a set of TCI states may consist of at least one primary TRP/TCI state and one or multiple secondary TRPs/TCI states. In single TRP scenario, a single set of TCI states may be used. In massively distributed MIMO with massive TRPs, multiple sets of TCI states each for a TRP may be used.

SSB and/or CSI-RS could be used as source RSs. PDCCH and PDSCH may be targeted signal and channel. PDCCH DMRS and/or PDSCH DMRS may be target RSs.

In another solution, according to an embodiment, gNB may indicate available TRP/TCI states and WTRU may indicate the LBT status of TRPs/TCI states to gNB. In this example, only two TCI states per TRP are considered. If primary TCI state (P-TCI) is not in good condition for WTRU to receive PDSCH e.g., due to LBT failure, WTRU could indicate status of TCI states to WTRU using LBT status codepoint. If secondary TRP (P-TRP) is not in good condition for WTRU to receive PDSCH e.g., due to LBT failure, WTRU could indicate status of TRP/TCI states to WTRU using another LBT status codepoint.

Example method of massive TRP LBT operation indicator is shown in FIG. 6, Table 7. In this example, N codepoints are used for LBT status corresponding to M TRPs. Each TRP may employ two TCI states, namely primary TCI and secondary TCI. WTRU may report LBT status using one of the codepoints depending on LBT status of TRP and associated TCI states.

The solution could also be equally applied to PUSCH transmission for uplink transmission.

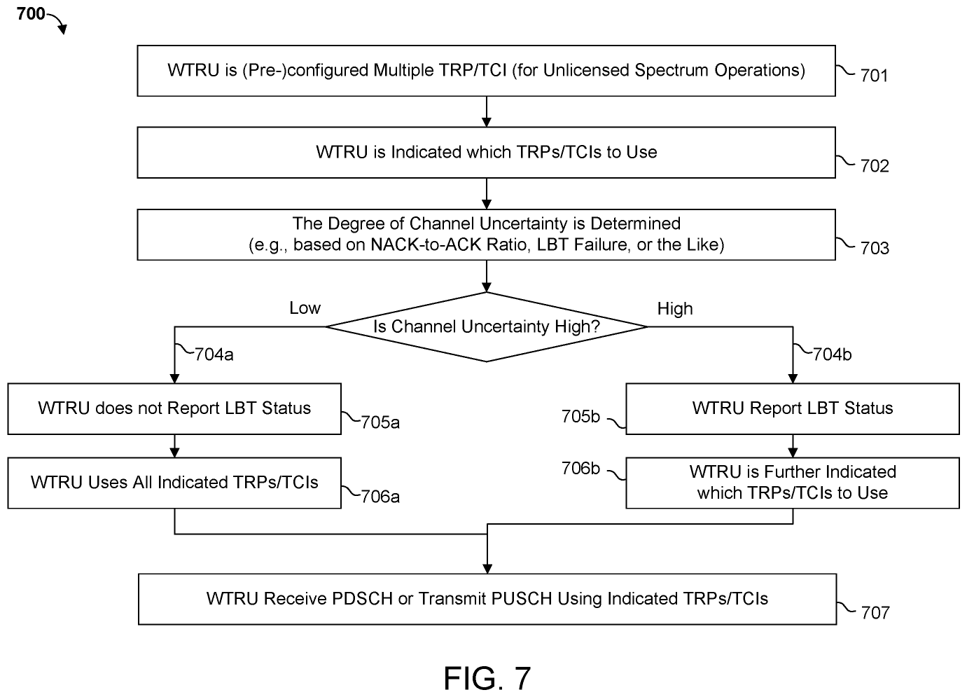

An embodiment of a method 700 of adaptive LBT mode operations is depicted in FIG. 7.

A WTRU may be (pre-)configured with multiple TRPs/TCIs e.g., for unlicensed spectrum operations, 701. The WTRU may be indicated 702 which TRPs/TCI states to use. The degree of channel uncertainty may be determined 703 and reported. The channel uncertainty may be determined based on e.g., NACK-to-ACK ratio, number of LBT failures, or the like. Interference level may be measured and determined.

If channel uncertainty is determined to be high 704b, the WTRU may report, 705b, LBT status. The WTRU may report LBT status using one of the codepoints for LBT status as described previously. The WTRU may be further indicated, 706b, which TRPs/TCIs to use.

If channel uncertainty is determined to be low, 704a, the WTRU may not report, 705a, LBT status. The WTRU may use all indicated TRPs/TCI states, 706a.

The WTRU may, 707, receive PDSCH or transmit PUSCH using the indicated TRPs/TCIs.

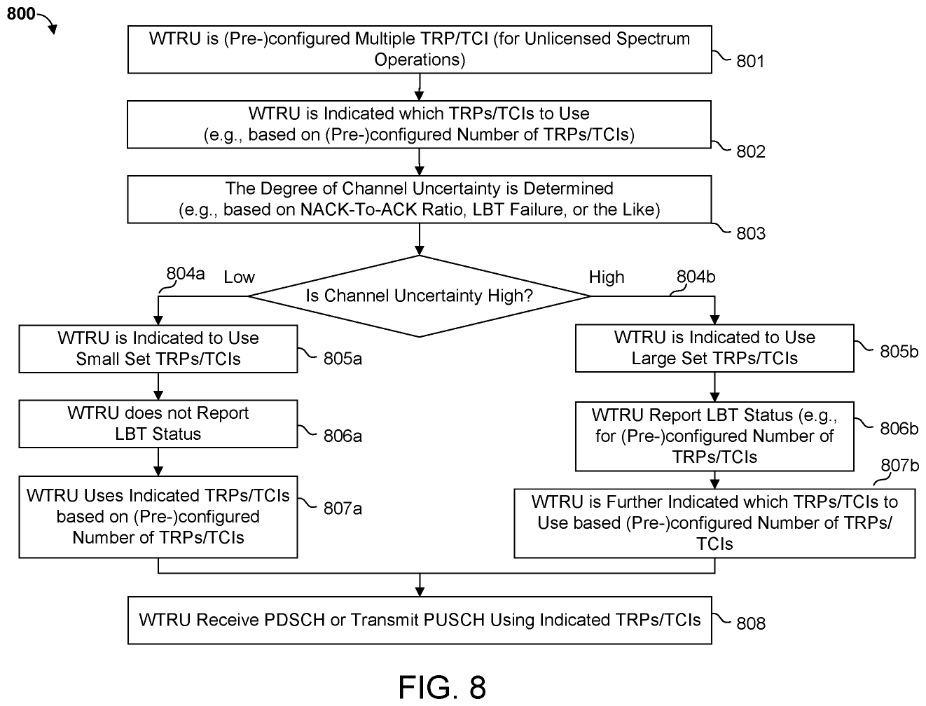

An embodiment of a method 800 of adaptive LBT mode operations is depicted in FIG. 8.

A WTRU may be (pre-)configured 801 with multiple TRPs/TCIs for unlicensed spectrum operations. The WTRU may be indicated 802 which TRPs/TCIs to use e.g., based on a (pre-)configured number of TRPs/TCIs.

The degree of channel uncertainty may be determined 803. The channel uncertainty may be determined based on e.g., NACK-to-ACK ratio, LBT failure, or the like.

If channel uncertainty is determined to be high 804b, the WTRU may be indicated to use a large set 805b of TRPs and/or TCI states. The WTRU may report LBT status e.g., for a (pre-)configured number of TRPs/TCIs. The WTRU may report 806b the LBT status using one of the codepoints for LBT status as described previously. The WTRU may be further indicated 807b which TRPs/TCI states to use based on (pre-)configured number of TRPs/TCIs.

If channel uncertainty is determined to be low 804a, the WTRU may be indicated 805a to use small set of TRPs and/or TCI states. The WTRU may not report 806a LBT status. The WTRU may use 807a indicated TRPs/TCI states based on (pre-)configured number of TRPs/TCIs.

The WTRU may, 808, receive PDSCH or transmit PUSCH using the indicated TRPs/TCIs.

Determining channel uncertainty may also be performed based on prediction, e.g., using Artificial Intelligence/Machine Learning (AI/ML), historical data, or the like.

### Representative Example of Methods of TRP/TCI Adaptation for Unlicensed Massively Distributed MIMO

In a highly dense network, a WTRU may connect with massive number of TRPs in massively distributed MIMO scenarios. A WTRU may receive data via DL channel e.g., PDSCH from massive TRPs, or may transmit data via UL channel e.g., PUSCH to massive number of TRPs. Such transmission or reception may be either coherent or non-coherent. WTRU may first receive downlink control information (DCI) via DL control channel e.g., PDCCH from one or more TRPs.

According to an embodiment, to further enhance performance, gNB may indicate more than two available TCI states, and WTRU may report combination of LBT status to gNB. gNB may indicate single TCI state (e.g., either P-TCI, or one of S-TCIs). gNB may also indicate more than one TCI states (e.g., combination of P-TCI and S-TCIs). Whether single TCI, two or more than two TCI states are used may be indicated to WTRU and may be based on dynamic manner of interference or hidden nodes. If interference or hidden nodes are dynamic, then more than one (or more than two) TCI states may be indicated. Otherwise, single TCI state (or two TCI states) may be indicated to WTRU.

If WTRU reports certain TCIs that are in good condition, but later measurements or decoding results within a certain period of time show that they may not be in good condition (e.g., LBT fails, NACKs are generated), then interference or hidden node may be dynamic. Otherwise, it may be less dynamic or semi-static.

When channel uncertainty is high (e.g., LBT failure is high), then gNB may indicate more available TCI states, otherwise, gNB may indicate less available TCI states or single available TCI state.

Two LBT modes may be used—one for high channel uncertainty, and one for low channel uncertainty. Two DCI formats may be used accordingly-one for long format (high payload) and one for short format (low payload). Similarly, Two PUCCH formats may be used accordingly—one for long format (high payload) and one for short format (low payload). PDCCH or DCI may be used to carry TCI codepoints or the like. PUCCH may be used to carry LBT status, interference level or the like.

WTRU may switch between two LBT modes. Switch may be based on measurements e.g., LBT failure, NACK-to-ACK ratio, CBR, CR, etc. Operation mode and DCI format may be associated with each other to reduce blind decoding complexity. For example, short DCI format may be associated with LBT operation mode 1 while long DCI format may be associated with LBT operation mode 2. If LBT mode 1 is indicated, WTRU may search for short DCI format only. If LBT mode 2 is indicated, WTRU may search for long DCI format only.

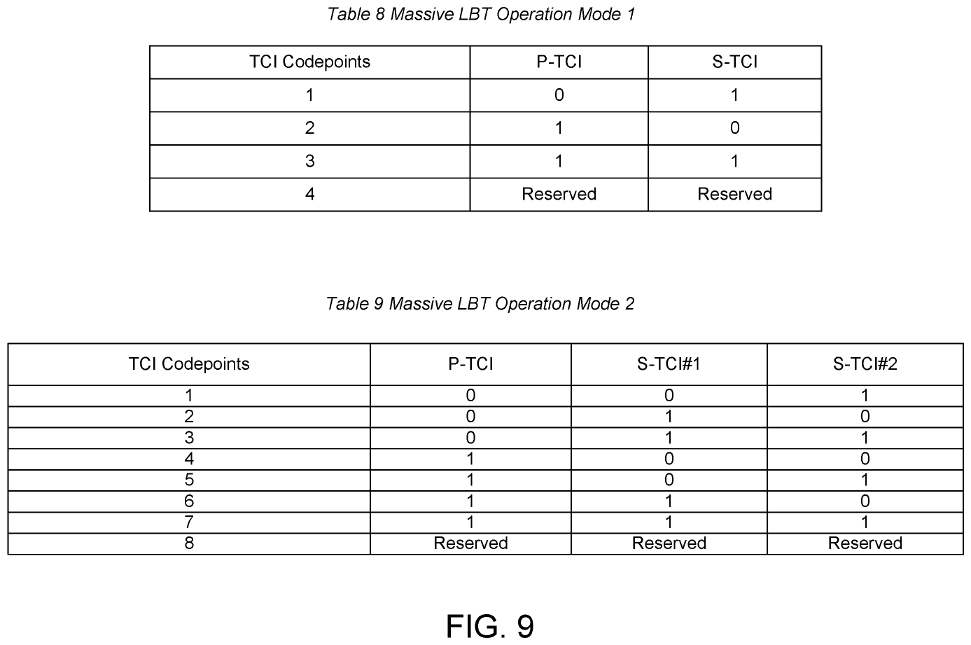

An example method of massive LBT operation mode 1 is shown in FIG. 9, Table 8.

An example method of massive LBT operation mode 2 is shown in FIG. 9, Table 9.

TCI codepoint may be indicated in TCI field in downlink control information (DCI) carried by PDCCH. gNB may indicate available TCI states using TCI codepoint in PDCCH. LBT status codepoint may be indicated in PUCCH. Alternatively, LBT status codepoint may be indicated in LBT field in uplink control information (UCI) carried by PUSCH.

LBT status report and/or interference report may be sent with and without data. gNB may trigger WTRU to send LBT status report including LBT status codepoint even if data or PUSCH is not scheduled. gNB may trigger WTRU to send LBT status and/or interference level with or without data transmission and LBT status report with or without interference level may be carried in UCI. In addition, LBT status report and/or interference report may be sent with and without other uplink control information.

A new DCI format may be needed for supporting additional or extended TCI field(s) and LBT status field if LBT status field is transmitted in DCI. Alternatively, a confirmation bit or confirmation message may be used to echo WTRU LBT status report. A confirmation bit or confirmation message for LBT status may be included in DCI. New DCI format may be introduced and DCI format 0_3, DCI format 0_4, DCI format 5_0 or DCI format 6_0 could be introduced to support unlicensed band beam-based operations for massively distributed MIMO.

A new PUCCH format may be required to support LBT status codepoint or joint LBT status and ACK/NACK if they are carried in PUCCH. One PUCCH format may be used to carry LBT status codepoint only. Or another PUCCH format may be used to carry LBT status codepoint and HARQ ACK/NACK jointly. Or another PUCCH format may be used to carry LBT status codepoint, HARQ ACK/NACK and other UCI jointly. PUSCH may also be used to carry LBT status, interference level and HARQ ACK/NACK or other uplink control information.

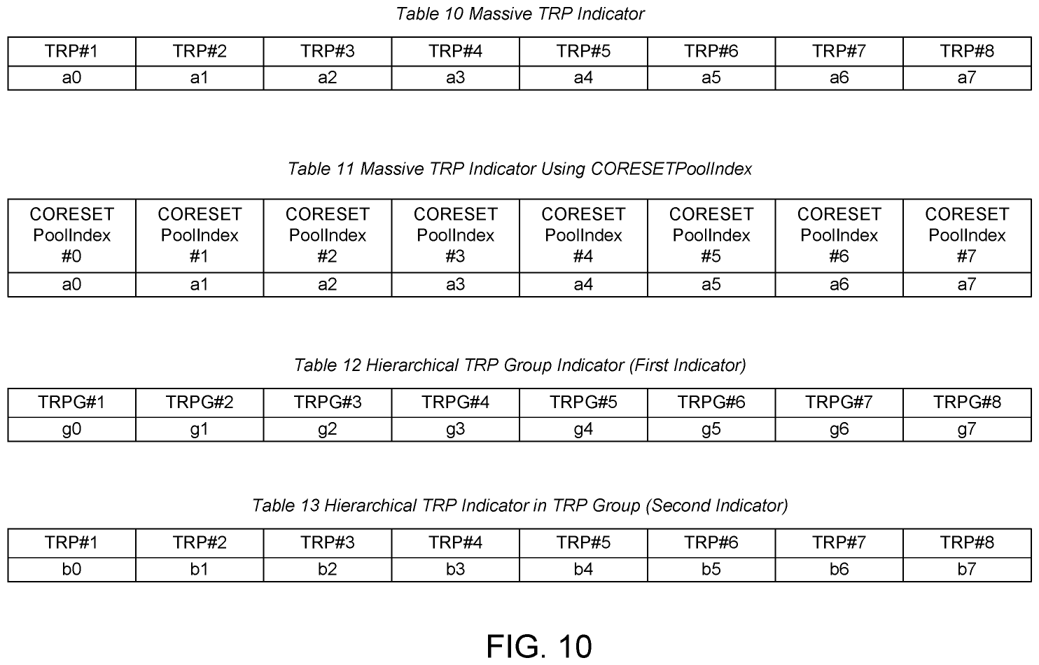

WTRU may report the LBT status of the indicated TCI states to gNB using LBT status codepoint. An example method of massive TRP indication is shown in FIG. 10, Table 10. The example shows 8 TRPs. WTRU may receive indication for TRPs from which WTRU may receive PDSCH. If a_i=“1”, it may imply that LBT passes at TRP for the i-th TRP, if a_i=“0”, it may imply that LBT does not pass at TRP for the i-th TRP.

The method could be extended to massive TRPs with number of TRPs much larger than 8, for example, 16 TRPs, 32 TRPs, 64 TRPs or larger.

An example method of massive TRP operation indication using CORESETPoolIndex is shown in FIG. 10, Table 11. The example shows 8 TRPs. WTRU may receive indication for TRPs from which WTRU may receive PDCCH and/or PDSCH. If a_i=“1”, it implies that LBT passes at TRP or CORESET pool for the i-th TRP, if a_i=“0”, it implies that LBT does not pass at TRP or CORESET pool for the i-th TRP.

Similarly, the method may be extended to massive TRPs with number of TRPs much larger than 8, for example, 16 TRPs, 32 TRPs, 64 TRPs or larger.

For massive number of TRPs, the overhead of signaling could be high. To reduce signaling overhead, a hierarchical group indication method may be used. TRPs may be grouped into multiple groups. Two TRP indications may be used, one is TRP group (TRPG) indication and the other is TRP indication within the TRP group (TRPG). TRP group indicator may indicate whether the TRP group passes LBT or not. TRP indicator may indicate whether the TRP in the TRP group passes LBT or not. In the following, the terms TRP group and TRPG have a same meaning and may be used indifferently.

For the example of M=64 TRPs, 8 TRP groups may be used. Each TRP group may consist of 8 TRPs. A hierarchical indication mechanism with first and second indication may be used. TRP group indicator (or the first indicator) is shown in FIG. 10, Table 12. TRP indicator in TRP group (or the second indicator) is shown in FIG. 10, Table 13.

WTRU may receive the first indication for TRPs from which WTRU may receive PDSCH. If g_i=“1”, it implies that LBT passes at TRPs for the i-th TRP group, if g_i=“0”, it implies that LBT does not pass at TRPs for the i-th TRP group. WTRU may receive the second indication for TRPs from which WTRU may receive PDSCH. If b_i=“1”, it implies that LBT passes at TRP for the i-th TRP in the TRP groups that are indicated “pass”, if b_i=“0”, it implies that LBT does not pass at TRP for the i-th TRP in the TRP groups that are indicated “pass”.

By using two TRP indicators, the signaling overhead could be significantly reduced. For M=64 TRPs, the embodiment of single TRP indicator may require 64 bits. The embodiment of hierarchical two TRP indicators may requires 8 bits for TRP group indicator and another 8 bits for TRP indicator in TRP group. It requires 16 bits for two indicators (the first and second indicators) in total. As compared to 64 bits for single TRP indication method, it could significantly reduce the signaling overhead by 4 folds. This could reduce payload burden in DCI if such indicator(s) are included in DCI.

Similarly, CORESET pools may be grouped into multiple CORESET pool groups. To reduce signaling overhead, a hierarchical group indication for CORESET pools may be used. CORESET pools may be grouped into several CORESET pool groups. Two CORESET pool indications may be used, one is CORESET pool group indication (CORESETPoolGRPIndex) and the other is CORESET pool indication within the CORESET pool group. CORESET pool group indicator may indicate whether the CORESET pool group passes LBT or not. CORESET pool indicator may indicate whether the CORESET pool in the CORESET pool group passes LBT or not.

For M=64 TRPs or 64 CORESET pools, 8 CORESET pool groups may be used. Each CORESET pool group may consist of 8 CORESET pools.

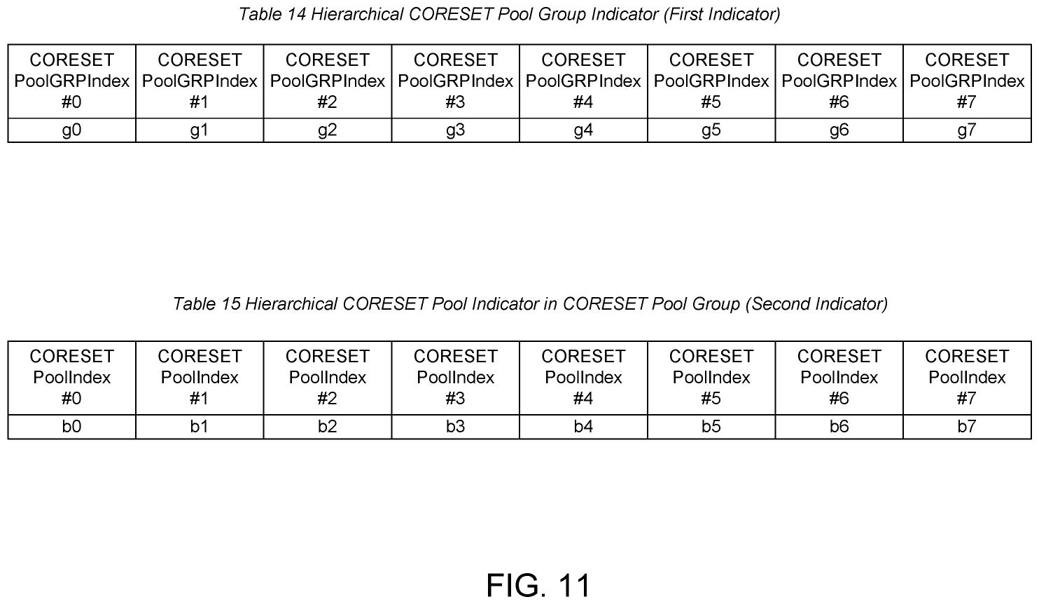

CORESET pool group indicator (CORESETPoolGRPIndex) is shown in FIG. 11, Table 14. CORESET pool indicator in CORESET pool group is shown in FIG. 11, Table 15.

WTRU may receive the first indication for CORESET pools from which WTRU may receive PDCCH and/or PDSCH. If g_i=“1”, it implies that LBT passes at TRPs or CORESET pools for the i-th TRP group or CORESET pool group, if g_i=“0”, it implies that LBT does not pass at TRPs or CORESET pools for the i-th TRP group or CORESET pool group. WTRU may receive the second indication for CORESET pools from which WTRU may receive PDCCH and/or PDSCH. If b_i=“1”, it implies that LBT passes at TRP or CORESET pool for the i-th TRP or CORESET pool in the CORESET pool groups that are indicated “pass”, if b_i=“0”, it implies that LBT does not pass at TRP or CORESET pool for the i-th TRP or CORESET pool in the CORESET pool groups that are indicated “pass”.

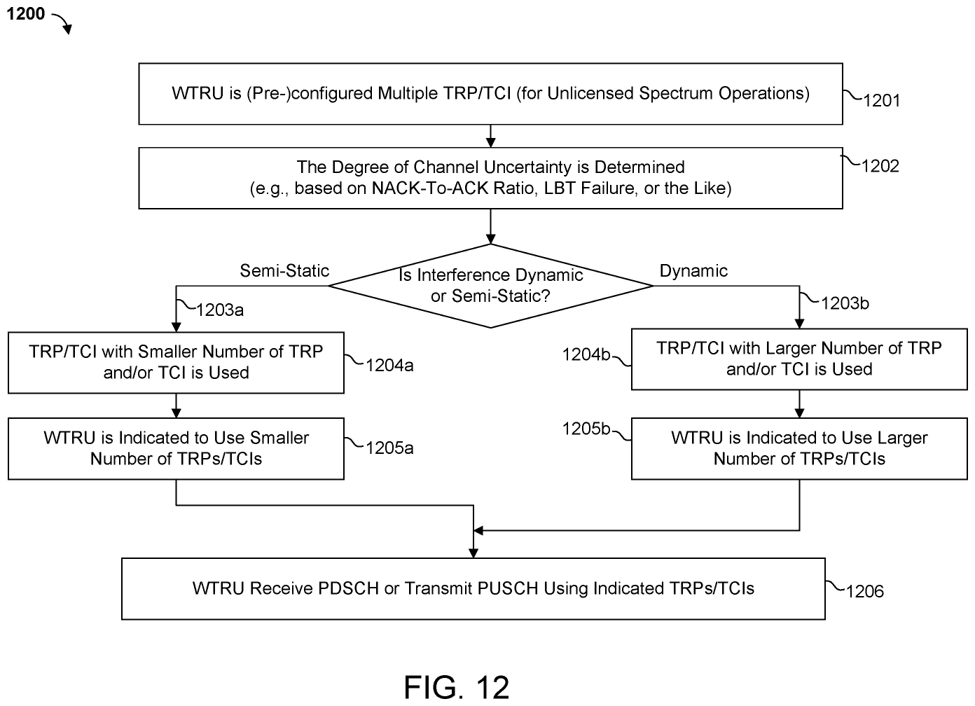

An embodiment of a method 1200 of adaptive TRP/TCI operations is depicted in FIG. 12.

A WTRU may be (pre-)configured 1201 with multiple TRPs/TCIs e.g., for unlicensed spectrum operations. The degree of interference may be determined 1201 e.g., based on NACK-to-ACK ratio, LBT failure, or the like.

If the interference is dynamic 1203b, then 1204b TRP/TCI with larger number of TRP and/or TCI may be used. The WTRU may be indicated 1205b to use larger number of TRPs/TCIs

If the interference is less dynamic or semi-static 1203a, then TRP/TCI with smaller number of TRP and/or TCI may be used, 1204a. The WTRU may be indicated 1205a to use smaller number of TRPs/TCI states.

The WTRU may 1206, receive PDSCH or transmit PUSCH using the indicated TRPs/TCI states.

### Representative Example of Methods of PDSCH/PUSCH Transmission/Reception Opportunities for Unlicensed Massively Distributed MIMO

More PDSCH and/or PUSCH reception and/or transmission opportunities may be created to enhance opportunities to cope with channel uncertainty in unlicensed band.

Enhanced time domain resource allocation (TDRA) with multiple entries or TDRA control fields in each codepoint may be used. The TDRA codepoint table may be configured by RRC. Multiple TDRA tables may be configured. One TDRA table may contain more entries for PDSCH or PUSCH e.g., in time domain for more transmission opportunities and cope with channel uncertainty in unlicensed spectrum. Another TDRA table may contain less entries for PDSCH or PUSCH e.g., in time domain to mitigate transmission or reduce repetition for better efficiency. Which TDRA table to use may be activated by MAC CE. Alternatively, which TDRA table to use may be indicated by DCI carried in PDCCH. TDRA mode may be indicated by one or multiple bits depending on the number of TDRA tables that are configured or pre-configured. For the embodiment of using two TRDA tables, one bit may be sufficient. If more than two TDRA tables are configured or activated, then 2 bits or more may be needed.

Depending on degree of channel uncertainty, TDRA table may be switched from one TDRA table or mode to another TDRA table or mode. For example, in case of high degree of channel uncertainty, TDRA table with more codepoints may be used and WTRU may be indicated to use such TDRA table to cope with channel uncertainty. On the other hand, if degree of channel uncertainty is low, then TDRA table with less codepoints may be used and WTRU may be indicated to use TDRA table with less codepoints to reduce complexity and overhead.

Depending on degree of channel uncertainty, TDRA table subset may be switched from one TDRA table or subset to another TDRA table subset. For example, in case of high degree of channel uncertainty, TDRA table or subset with more codepoints may be used and WTRU may be activated to use such TDRA table or subset. On the other hand, if degree of channel uncertainty is low, then TDRA table or subset with less codepoints may be used and WTRU may be activated to use TDRA table with less codepoints. WTRU may be further indicated which codepoint or codepoints to use among activated codepoints, subset or table.

Multiple TDRA tables may be configured or pre-configured. One solution is that one of TDRA table may be indicated to WTRU to use. TDRA table indicator may be included in control field in DCI or TDRA control field may be included in DCI. This may be used to cope with fast changing channel uncertainty. Another embodiment may be that a subset of TDRA tables may be activated among configured or pre-configured TDRA tables. After TDRA table activation, an exact TDRA table among the activated TDRA tables may be indicated to WTRU. This may be used to cope with changing channel uncertainty with lower DCI overhead.

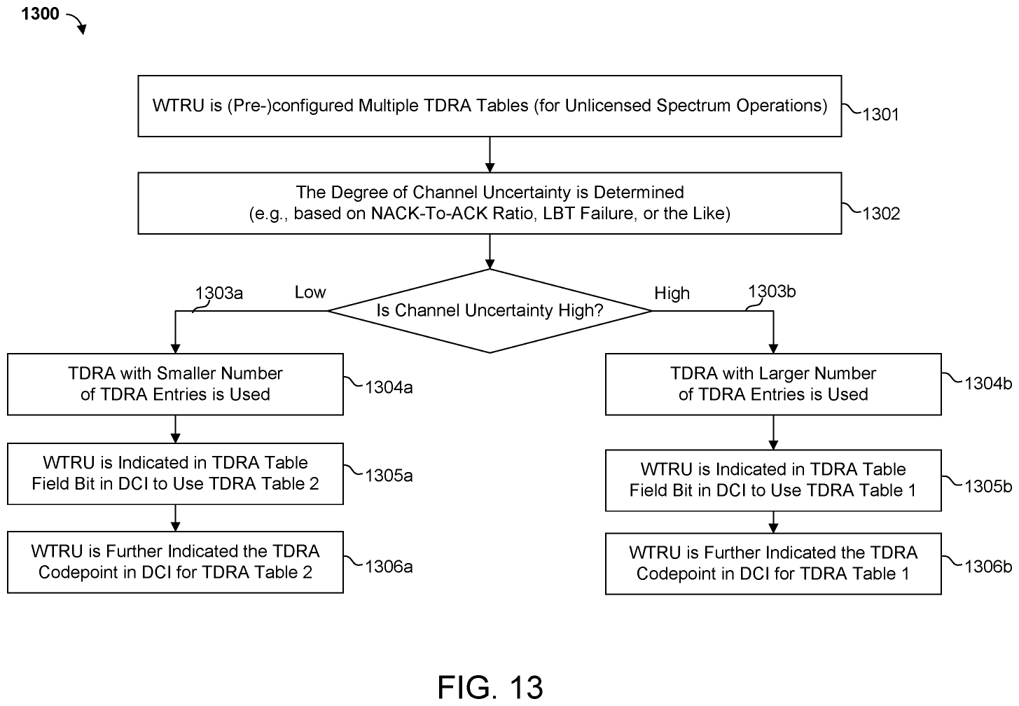

An embodiment of a method 1300 of TDRA mode operations (indication) is depicted in FIG. 13.

A WTRU may be (pre-)configured 1301 with multiple TDRA configurations or tables e.g., for unlicensed spectrum operations. The degree of channel uncertainty may be determined 1302 (e.g., based on NACK-to-ACK ratio, LBT failure, or the like). TDRA configurations or TDRA tables may be used interchangeably.

If the channel uncertainty is determined to be high (large) 1303b, then TDRA with larger, 1304b, number of TDRA entries may be used. The WTRU may be indicated 1305b in TDRA configuration selection field bit in DCI to use TDRA configuration 1. The WTRU may 1306b be further indicated for the TDRA codepoint in DCI for TDRA configuration 1.

If the channel uncertainty is determined to be low (small) 1303a, then 1304a TDRA with smaller number of TDRA entries may be used. The WTRU may be indicated 1305a in TDRA configuration selection field bit in DCI to use TDRA configuration 2. The WTRU may be further indicated 1306a the TDRA codepoint in DCI for TDRA configuration 2.

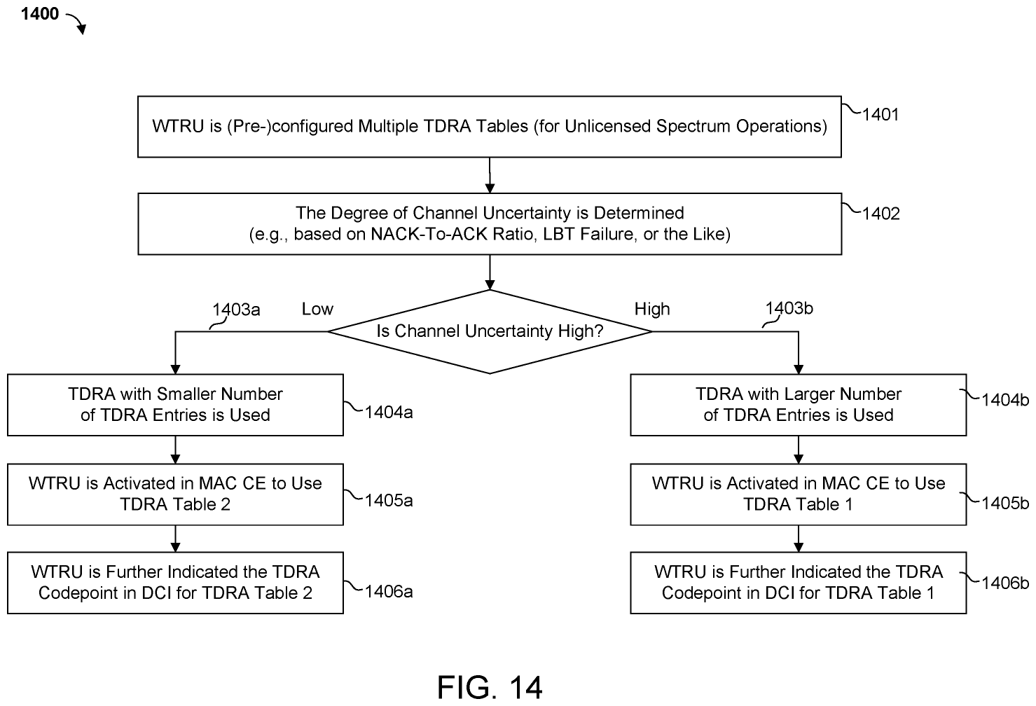

An embodiment of a method 1400 of TDRA mode operations (activation) is depicted in FIG. 14.

A WTRU may be (pre-)configured 1401 with multiple TDRA configurations (for unlicensed spectrum operations). The degree of channel uncertainty may be determined 1402 e.g., based on NACK-to-ACK ratio, LBT failure, or the like.

If the channel uncertainty is determined to be high (large) 1403b, then TDRA with larger number of TDRA entries may be used, 1404b. The WTRU may be activated 1405b in MAC CE to use TDRA configuration 1. The WTRU may be further indicated 1406b the TDRA codepoint in DCI for TDRA configuration 1.

If the channel uncertainty is determined to be low (small) 1403a, then TDRA with smaller number of TDRA entries may be used, 1404a. The WTRU may be activated 1405a in MAC CE to use TDRA configuration 2. The WTRU may be further indicated 1406a the TDRA codepoint in DCI for TDRA configuration 2.

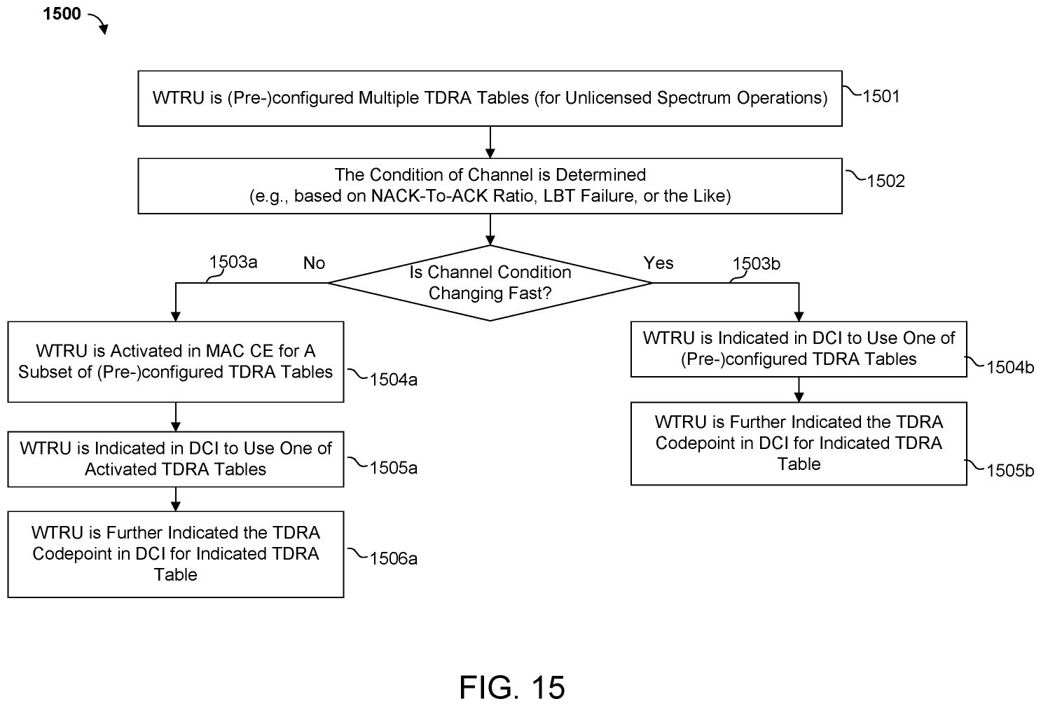

An embodiment of a method 1500 of TDRA mode operations (activation/indication) is depicted in FIG. 15.

A WTRU may be (pre-)configured 1501 with multiple TDRA tables (for unlicensed spectrum operations). The condition of channel may be determined 1502 (e.g., based on NACK-to-ACK ratio, LBT failure, or the like).

If the channel condition is changing fast 1503b, then the WTRU may be indicated 1504b in DCI to use one of the (pre-)configured TDRA configurations. The WTRU may be further indicated 1505b the TDRA codepoint in DCI for the indicated TDRA configuration.

If channel condition is not changing fast 1503a, then the WTRU may be activated 1504a in MAC CE for a subset of TDRA configurations that are configured or pre-configured. The WTRU may be indicated 1505a in DCI to use one of activated TDRA configurations. The WTRU may be further indicated 1506a the TDRA codepoint in DCI for the indicated TDRA configuration.

### Representative Example of Methods of Efficient Operations for Unlicensed Massively Distributed MIMO

According to an embodiment, in unlicensed band, to enable more efficient operation and cope with channel uncertainty, WTRU may indicate the LBT status of TCI states, TRPs and resources e.g., resource block (RB) or RB set to gNB. gNB may indicate available TCI states, TRPs and resources e.g., resource block (RB) or RB set to WTRU.

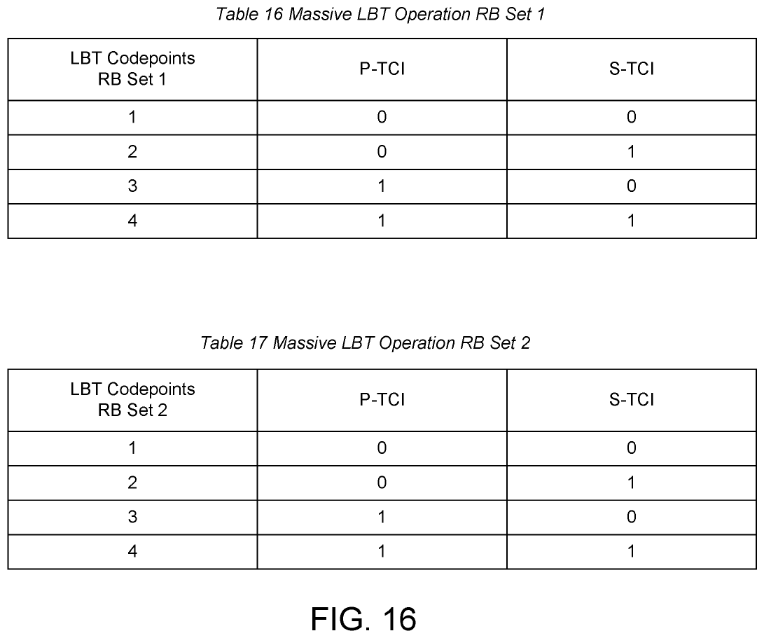

In the example shown in FIG. 16, Table 16 and Table 17, only two TCI states and two RB set resources/subbands are considered.

If primary TCI state (P-TCI) for resource 1 or RB set 1 and secondary TCI state (S-TCI) for resource 2 or RB set 2 are not in good condition for WTRU to receive PDSCH due to interference e.g., LBT failures, hidden nodes, WTRU could indicate LBT status of TCI states to gNB using LBT status codepoint 2 and codepoint 3 respectively as shown in Table 16 and Table 17.

If primary TCI state (P-TCI) for resource 1 or RB set 1 for TRP 1 and secondary TCI state (S-TCI) for RB set resource 2 for TRP 2 are not in good condition for WTRU to receive PDSCH e.g., due to interference, LBT failures, hidden nodes, or the like, WTRU could indicate LBT status of TCI states, TRPs and RB sets to gNB using LBT status codepoint 2 and codepoint 3 respectively.

WTRU may report the LBT status of indicated TCI states, TRPs and RB sets or subbands to gNB using LBT status codepoint for different RB sets or subbands.

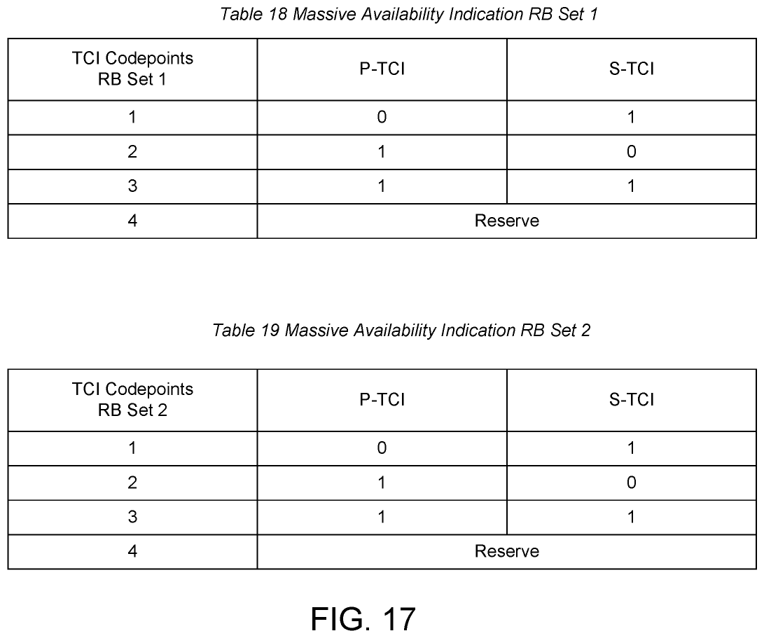

gNB may indicate available TCI states, TRPs and RB set resources, RB sets or subbands to WTRU using TCI codepoints for different resources as shown in FIG. 17, Table 18 and Table 19.

WTRU may receive confirmation message from gNB whether it can assume that TCI states reported in LBT status report may be used. If “1”, it implies the LBT status report is confirmed to be used. If “0”, it implies the LBT status report is not confirmed to be used.

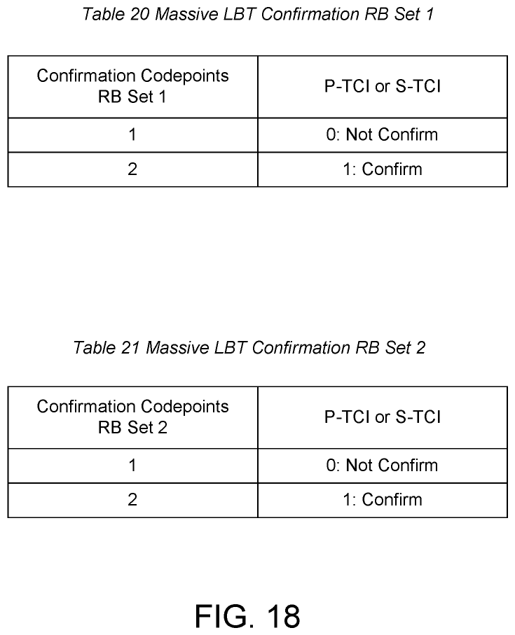

Examples of massive LBT confirmation messages for RB set 1 and RB set 2 are shown in FIG. 18, Table 20 and Table 21 correspondingly.

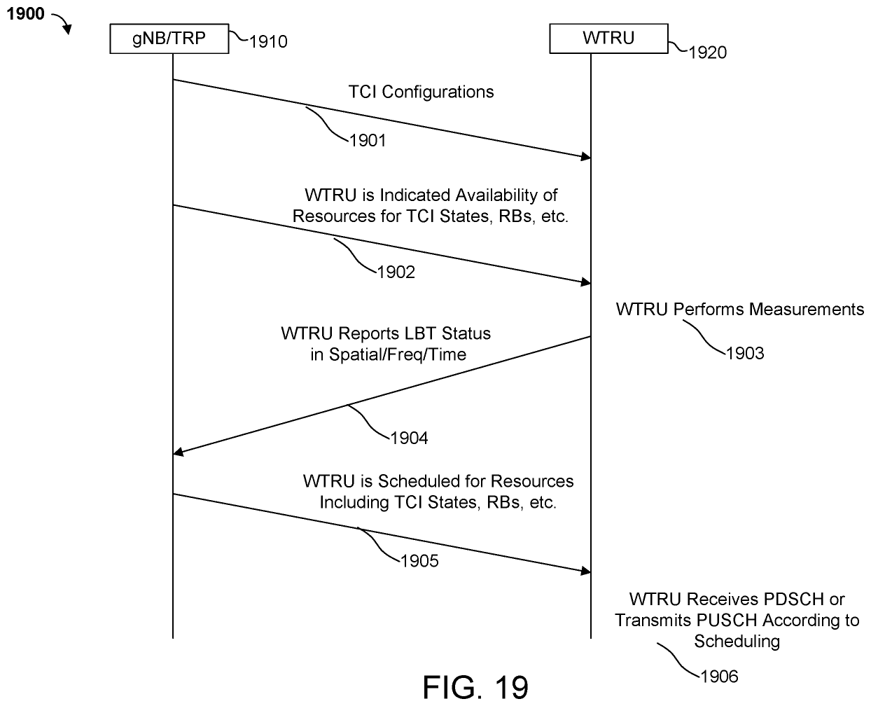

An embodiment of a method 1900 of adaptive unlicensed spectrum operations is depicted in FIG. 19.

A WTRU 1920 may receive 1901 TCI configuration(s). The WTRU may be indicated 1902 availability of resources for TCI states, RBs, RB sets, etc. The WTRU may perform 1903 measurements on the indicated available TCI states and resources. The WTRU may report 1904 LBT status in spatial/freq/time domains for the indicated available TCI states and resources. The WTRU may be scheduled 1905 for resources including TCI states, RBs, etc. The WTRU may receive 1906 PDSCH or transmits PUSCH according to scheduling information.

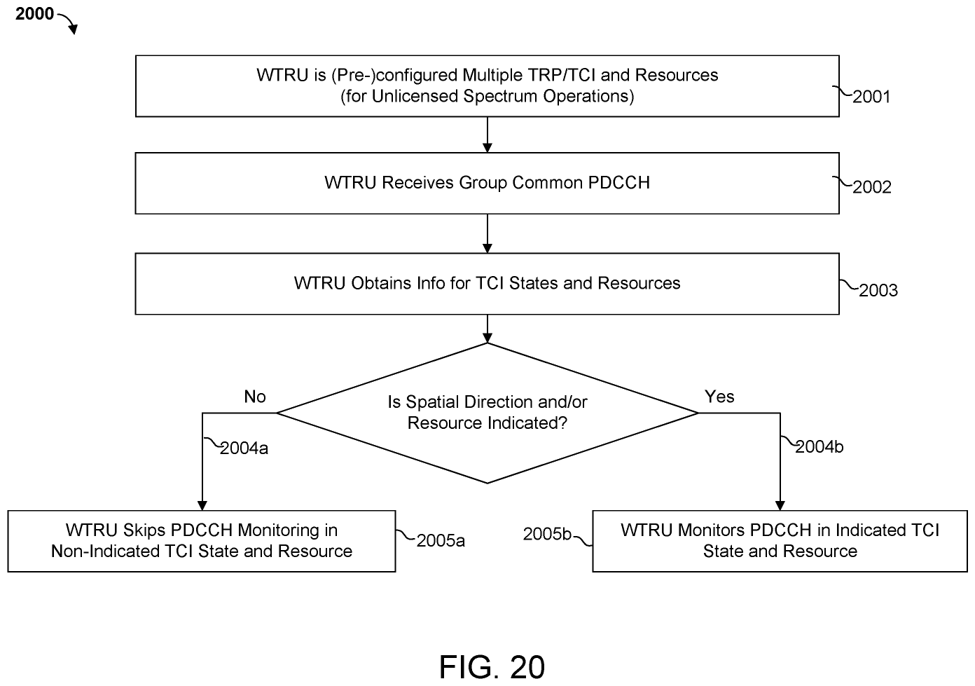

An embodiment of a method 2000 of adaptive LBT mode operations is depicted in FIG. 20.

A WTRU may be (pre-)configured 2001 with multiple TRPs/TCI states and resources e.g., for unlicensed spectrum operations. The WTRU may receive 2002 group common PDCCH (GC-PDCCH). The WTRU may obtain 2003 control information in group common DCI (GC-DCI) for TCI states and resources.

If the spatial direction and/or resource is indicated 2004b, then WTRU may monitor 2005b PDCCH in indicated TCI state and resource or resource set.

If the spatial direction and/or resource is not indicated, 2004a, then the WTRU may skip, 2005a, PDCCH monitoring in TCI state and resource or resource set that are not indicated.

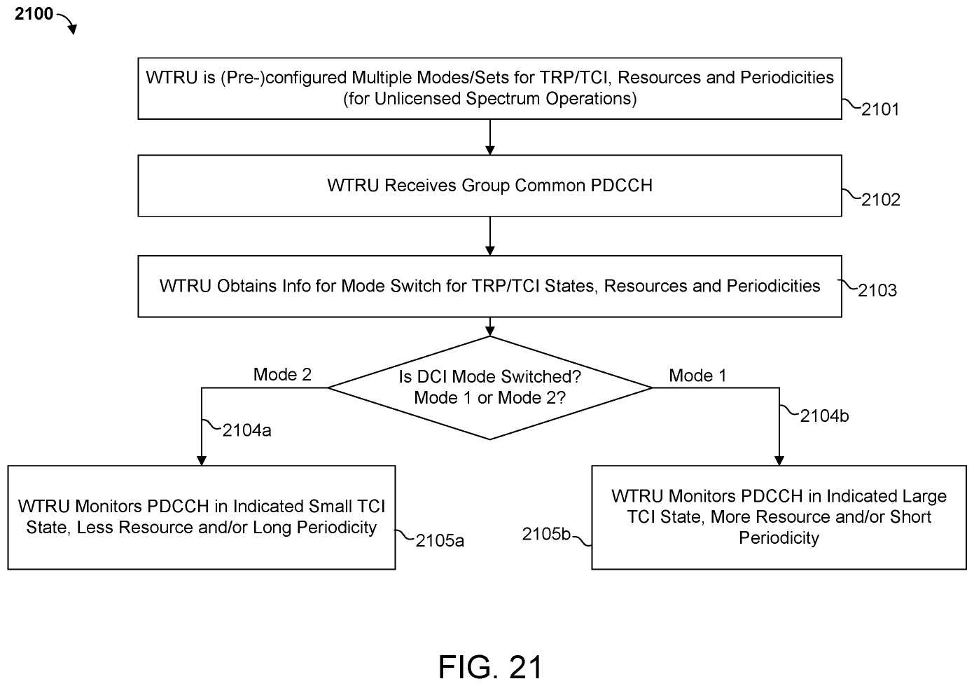

An embodiment of a method 2100 of adaptive LBT mode operations is depicted in FIG. 21.

A WTRU may be (pre-)configured 2101 with multiple modes/sets for TRPs/TCIs, resources, and periodicities e.g., for unlicensed spectrum operations. The WTRU may receive 2102 group common PDCCH or GC-PDCCH. The WTRU may obtain 2103 control information, DCI or GC-DCI for mode switch for TRPs/TCI states, resources, and periodicities.

Control information, DCI or GC-DCI may indicate mode switch or the operation mode. If mode 1 is indicated 2104b, then the WTRU may monitor 2105b PDCCH in the indicated large TCI states, more resources and/or short periodicity.

If mode 2 is indicated 2104a, then the WTRU may monitor 2105a DCCH in the indicated small TCI states, less resources and/or long periodicity.

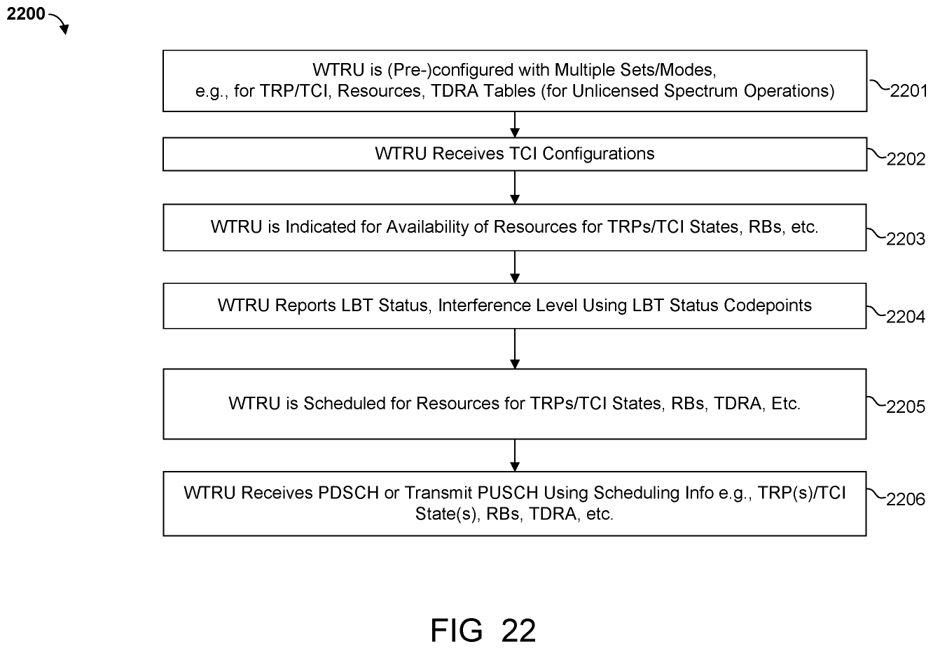

An embodiment of a method 2200 of efficient adaptive unlicensed spectrum operations for massively distributed MIMO with massive number of TRPs is depicted in FIG. 22.

A WTRU may be (pre-)configured 2201 with multiple sets/modes, e.g., for TRP/TCI, resources, TDRA tables (for unlicensed spectrum operations). The WTRU may receive 2202 TCI configurations. The WTRU may be indicated 2203 for availability of resources for TRPs/TCI states, RBs, etc. The WTRU may report 2204 LBT status with or without interference level using LBT status codepoints. The WTRU may be scheduled 2205 for resources for TRPs/TCI states, RBs, TDRA, etc. The WTRU may receive 2206 PDSCH or transmit PUSCH using scheduling information e.g., TRP(s)/TCI state(s), RBs, TDRA, etc.

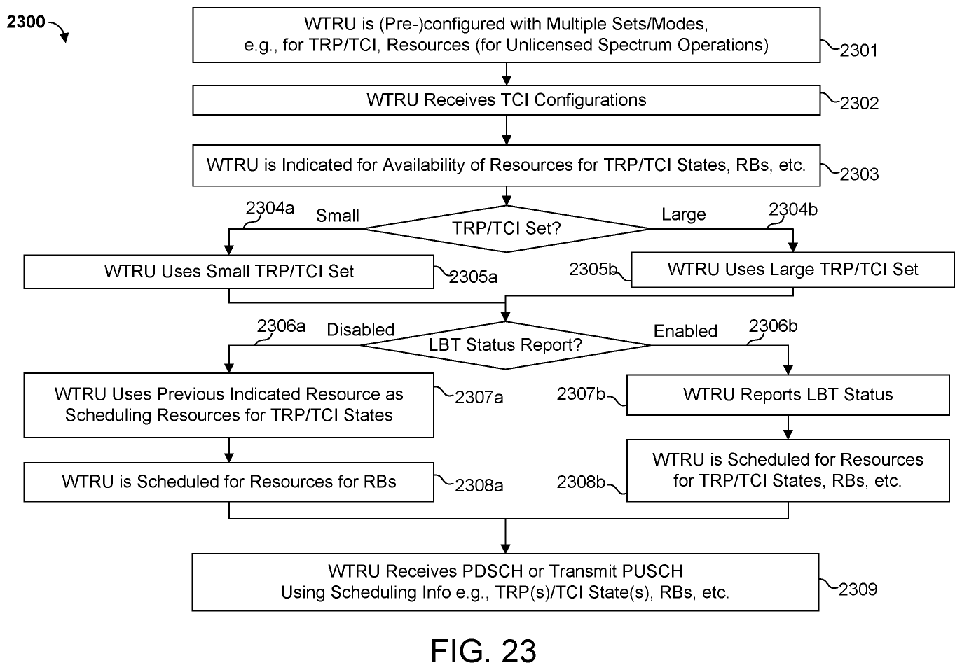

An embodiment of a method 2300 of efficient adaptive unlicensed spectrum operations for massively distributed MIMO with massive number of TRPs and beams is depicted in FIG. 23.

A WTRU may be (pre-)configured 2301 with multiple sets/modes, e.g., for TRP/TCI, resources (for unlicensed spectrum operations). The WTRU may receive 2302 TCI configurations.

The WTRU may be indicated 2303 for availability of resources for TRP/TCI states, RBs, etc. Depending on channel condition and channel uncertainty, a proper set of TRP/TCI is indicated to optimize the unlicensed operation and system performance.

If large set of TRP/TCI is indicated 2304b, then the WTRU may use 2305b large TRP/TCI set.

If small set of TRP/TCI is indicated 2304a, then the WTRU may use 2305a small TRP/TCI set.

If LBT status report is enabled 2306b, then the WTRU may report 2307b LBT status on the indicated set of TRP/TCI. After reporting LBT status, the WTRU may be scheduled 2308b for resources for TRP/TCI states, RBs, etc.

If LBT status report is not enabled or disabled 2306a, then the WTRU may use 2307a previous indicated resource as scheduling resources for TRP/TCI states. The WTRU may be scheduled 2308b for resources for RBs.

The WTRU may receive 2309 PDSCH or transmit PUSCH accordingly using scheduling info e.g., TRP(s)/TCI state(s), RBs, etc. as indicated.

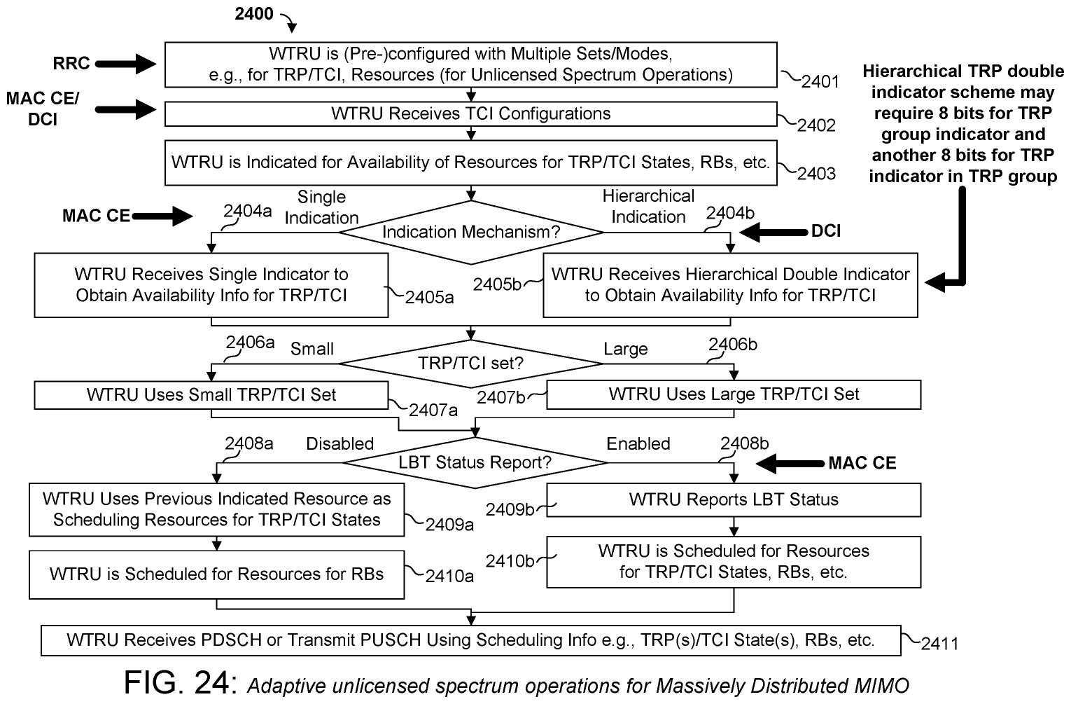

An embodiment of a method 2400 of efficient adaptive unlicensed spectrum operations for massively distributed MIMO with massive number of TRPs and beams is depicted in FIG. 24.

A WTRU may be (pre-)configured 2401 with multiple sets/modes, e.g., for TRP/TCI, resources (for unlicensed spectrum operations). The WTRU may receive 2402 TCI configurations.

The WTRU may be indicated 2403 for availability of resources for TRP/TCI states, RBs, etc.

If single indication mechanism is indicated 2404a, then the WTRU may receive 2405a a single indicator for TRP to obtain availability information for TRP/TCI.

If hierarchical indication mechanism is indicated 2404b, then the WTRU may receive 2405b double indicators for TRP to obtain availability information for TRP/TCI. The WTRU may receive a first indicator to obtain availability information for TRP groups. The WTRU may receive a second indicator to obtain availability information for TRPs in TRP groups. When the first and second indicators are combined, the WTRU may obtain a complete availability information for TRP/TCI.

Depending on channel condition and channel uncertainty, a proper set of TRP/TCI is indicated to optimize the unlicensed operation and system performance.

If large set of TRP/TCI is indicated 2406b, then the WTRU may 2407b use large TRP/TCI set.

If small set of TRP/TCI is indicated 2406a, then the WTRU may 2407a use small TRP/TCI set.

If LBT status report is enabled 2408b, then the WTRU may report 2409b LBT status on the indicated set of TRP/TCI. After reporting LBT status, the WTRU may be scheduled 2410b for resources for TRP/TCI states, RBs, etc.

If LBT status report is not enabled or disabled 2408a, then the WTRU may use 2409a previous indicated resource as scheduling resources for TRP/TCI states. The WTRU may be scheduled 2410a for resources for RBs.

The WTRU may receive 2411 PDSCH or transmit PUSCH accordingly using scheduling info e.g., TRP(s)/TCI state(s), RBs, etc. as indicated.

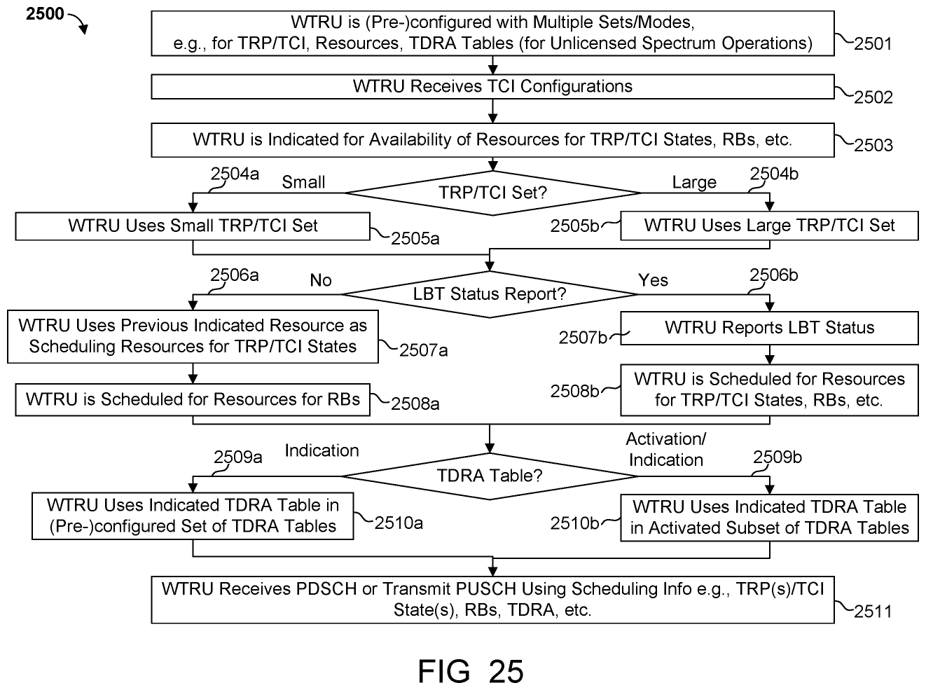

An embodiment of a method 2500 of efficient adaptive unlicensed spectrum operations for massively distributed MIMO with massive number of TRPs and beams is depicted in FIG. 25.

A WTRU may be (pre-)configured 2501 with multiple sets/modes, e.g., for TRP/TCI, resources, TDRA tables (for unlicensed spectrum operations). The WTRU may receive, 2502, TCI configurations.

The WTRU may be indicated, 2503, for availability of resources for TRP/TCI states, RBs, etc.

Depending on channel condition and channel uncertainty, a proper set of TRP/TCI is indicated to optimize the unlicensed operation and system performance.

If large set of TRP/TCI is indicated 2504b, then WTRU may use 2505b large TRP/TCI set.

If small set of TRP/TCI is indicated 2504a, then WTRU may use 2505a small TRP/TCI set.

If LBT status report is enabled 2506b, then the WTRU may report 2507b LBT status on the indicated set of TRP/TCI. After reporting LBT status, the WTRU may be scheduled 2508b for resources for TRP/TCI states, RBs, etc.

If LBT status report is not enabled or disabled 2506a, then the WTRU may use 2507a previous indicated resource as scheduling resources for TRP/TCI states. The WTRU may be scheduled 2508a for resources for RBs.

If TDRA mode with activation/indication is enabled 2509b, the WTRU may use 2510b indicated TDRA table in activated subset of TDRA tables.

If TDRA mode with indication is enabled 2509a, the WTRU may use 2510a indicated TDRA table in set of TDRA tables that are configured or pre-configured.

The WTRU may receive 2511 PDSCH or transmit PUSCH accordingly using scheduling info e.g., TRP(s)/TCI state(s), RBs, TDRA, etc. as indicated.

In one exemplary embodiment, a WTRU performs adaptive operation and procedure for unlicensed massively distributed MIMO (MD-MIMO).

The WTRU is configured for multiple sets/modes, e.g., for TRPs/TCIs, resources (for MD-MIMO unlicensed spectrum operations).

The WTRU may perform the following:
receive indication for availability of resources for TRP/TCI states, RBs, etc.,
use indicated set of TRPs/TCIs, e.g., large TRP/TCI set for high channel uncertainty and small TRP/TCI set for low channel uncertainty;
report LBT status on the indicated set of TRPs/TCIs if LBT status report is enabled;
receive scheduling information for resources for TRP/TCI states, RBs, etc., or use previous indicated resource as scheduling resources for TRPs/TCI states if LBT status report is not enabled or disabled;
receive scheduling information for resources for RBs;
receive PDSCH using scheduling information e.g., TRP(s)/TCI state(s), RBs, TDRA, etc. in case of downlink, or transmit PUSCH using scheduling information e.g., TRP(s)/TCI state(s), RBs, TDRA, etc. in case of uplink.

In another exemplary embodiment, a WTRU performs adaptive operation and procedure for unlicensed massively distributed MIMO (MD-MIMO).

The WTRU is configured for multiple sets/modes, e.g., for TRPs/TCIs, resources (for MD-MIMO unlicensed spectrum operations).

The WTRU may perform the following:
receive indication for availability of resources for TRP/TCI states, RBs, etc.,;
receive a single indicator for availability of resources for TRP/TCI states if single indication mechanism is indicated, or receive hierarchical double indicators for availability of resources for TRP/TCI states if hierarchical double indication mechanism is indicated (to reduce signaling overhead for massively distributed MIMO);
obtain availability information for TRP/TCI from TRP group indicator (first indicator) and TRP indicator in TRP group (second indicator) if hierarchical double indication mechanism is indicated;
use indicated set of TRPs/TCIs, e.g., large TRP/TCI set for high channel uncertainty and small TRP/TCI set for low channel uncertainty;
reports LBT status on the indicated set of TRPs/TCIs if LBT status report is enabled;
receives scheduling information for resources for TRP/TCI states, RBs, etc., or use previous indicated resource as scheduling resources for TRPs/TCI states if LBT status report is not enabled or disabled;
receive scheduling information for resources for RBs;
receive PDSCH using scheduling information e.g., TRP(s)/TCI state(s), RBs, TDRA, etc. if it is downlink, or transmit PUSCH using scheduling information e.g., TRP(s)/TCI state(s), RBs, TDRA, etc. if it is uplink.

In another exemplary embodiment, a WTRU performs adaptive unlicensed operation and procedure for massively distributed MIMO.

The WTRU may be (pre-)configured with multiple TRPs/TCIs (for unlicensed spectrum operations).

The WTRU may perform the following:
receive indication for which TRPs/TCI states to use;
determine the degree of channel uncertainty, e.g., the channel uncertainty may be determined based on e.g., NACK-to-ACK ratio, LBT failure, or the like;
if channel uncertainty is determined to be high, report LBT status using one of codepoints for LBT status. Receive further indication for which TRPs/TCIs to use;
if channel uncertainty is determined to be low, not report LBT status. Use all indicated TRPs/TCI states;
receive PDSCH or transmit PUSCH using the indicated TRPs/TCIs.

In yet another exemplary embodiment, a WTRU performs adaptive unlicensed operation and procedure for massively distributed MIMO.

The WTRU may be (pre-)configured with multiple TRPs/TCIs (for unlicensed spectrum operations).

The WTRU may perform the following:
receive indication for which TRPs/TCI states to use;
determine the degree of channel uncertainty, e.g., the channel uncertainty may be determined based on e.g., NACK-to-ACK ratio, LBT failure, or the like, and report channel uncertainty to gNB;
if channel uncertainty is determined to be high, receive indication to use large set of TRPs/TCI state;
if channel uncertainty is determined to be low, receive indication to use small set of TRPs/TCI state;
receive indication to use TRPs/TCI states in the determined set of TRPs/TCIs;
receive PDSCH or transmit PUSCH using the indicated TRPs/TCIs.

In yet another exemplary embodiment, a WTRU performs adaptive unlicensed operation and procedure for massively distributed MIMO.

The WTRU may be (pre-)configured with multiple TRPs/TCIs (for unlicensed spectrum operations).

The WTRU may perform the following:
receive TCI configurations;
receive indication for availability of resources for TRPs/TCI states, RBs, etc.;
report LBT status with or without interference level using LBT status codepoints;
receive scheduling information for resources for TRPs/TCI states, RBs, TDRA, etc.;
receive PDSCH if downlink or transmit PUSCH if uplink using scheduling information e.g., TRP(s)/TCI state(s), RBs, TDRA, etc.

In yet another exemplary embodiment, a WTRU performs adaptive operation and procedure for unlicensed massively distributed MIMO (MD-MIMO).

The WTRU is configured for multiple sets/modes, e.g., for TRPs/TCIs, resources, TDRA tables (for MD-MIMO unlicensed spectrum operations).

The WTRU may perform the following:
receive indication for availability of resources for TRP/TCI states, RBs, etc.; use indicated set of TRPs/TCIs, e.g., large TRP/TCI set for high channel uncertainty and small TRP/TCI set for low channel uncertainty;
reports LBT status on the indicated set of TRPs/TCIs if LBT status report is enabled;
receives scheduling information for resources for TRP/TCI states, RBs, etc., or use previous indicated resource as scheduling resources for TRPs/TCI states if LBT status report is not enabled or disabled;
receive scheduling information for resources for RBs;
use indicated TDRA table in activated subset of TDRA tables if TDRA mode with activation/indication is enabled or indicated, or use indicated TDRA table in (pre-)configured set of TDRA tables if TDRA mode with indication is enabled or indicated;
receive PDSCH using scheduling information e.g., TRP(s)/TCI state(s), RBs, TDRA, etc. if it is downlink, or transmit PUSCH using scheduling information e.g., TRP(s)/TCI state(s), RBs, TDRA, etc. if it is uplink.

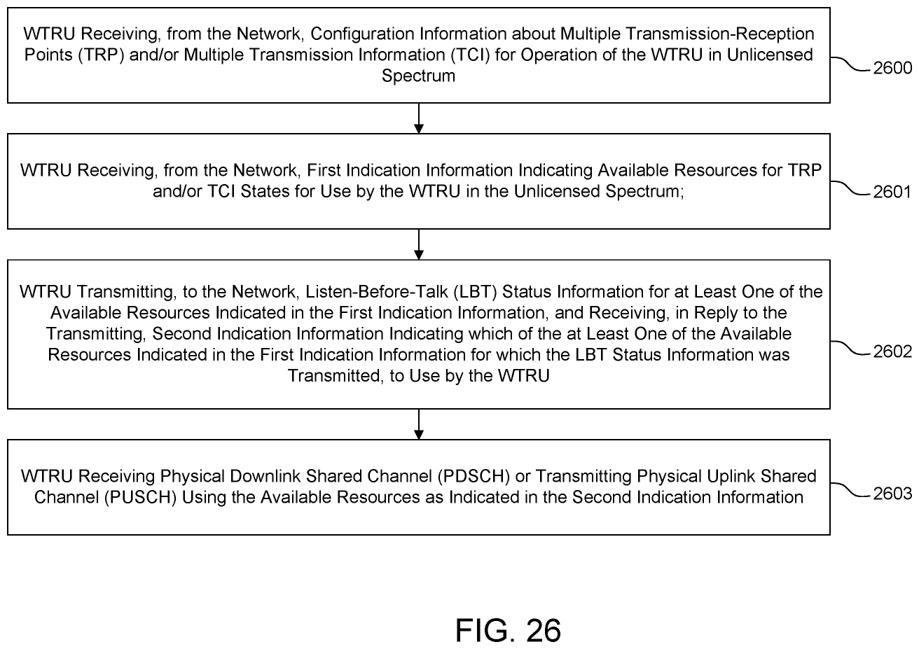

There is disclosed a method, implemented by a WTRU in a network (see FIG. 26). The method comprises:
receiving (2600), from the network, configuration information about multiple transmission-reception points (TRP) and/or multiple transmission information (TCI) for operation of the WTRU in unlicensed spectrum;
receiving (2601), from the network, first indication information indicating available resources for TRP and/or TCI states for use by the WTRU in the unlicensed spectrum;
transmitting (2602), to the network, listen-before-talk (LBT) status information for at least one of the available resources indicated in the first indication information, and receiving, in reply to the transmitting, second indication information indicating which of the at least one of the available resources indicated in the first indication information for which the LBT status information was transmitted, to use by the WTRU; and
receiving (2603), from the network, physical downlink shared channel (PDSCH) or transmitting, to the network, physical uplink shared channel (PUSCH) using the available resources as indicated in the second indication information.

According to a further embodiment of the method, the method includes determining the LBT status for the available resources indicated in the first indication information based on measurements comprising any of:
an ACK-to-NACK ratio of the available resources indicated in the first indication information;
a listen-before-talk failure of the available resources indicated in the first indication information.
an interference level of the available resources indicated in the first indication information.

According to a further embodiment of the method, the LBT status is transmitted to the network for the at least one of the available resources indicated in the first indication information from which the WTRU receives PDSCH.

According to a further embodiment of the method, the LBT status is transmitted to the network for the at least one of the available resources indicated in the first indication information from which the WTRU receives at least one of:
physical downlink control channel (PDCCH);
PDSCH.

There is disclosed a WTRU in a network, the WTRU comprising at least one processor. The at least one processor is configured to:
receive, from the network, configuration information about multiple transmission-reception points (TRP) and/or multiple transmission information (TCI) for operation of the WTRU in unlicensed spectrum;
receive, from the network, first indication information indicating available resources for TRP and/or TCI states for use by the WTRU in the unlicensed spectrum;
transmit, to the network, listen-before-talk (LBT) status information for at least one of the available resources indicated in the first indication information, and receiving, in reply to the transmitting, second indication information indicating which of the at least one of the available resources indicated in the first indication information for which the LBT status information was transmitted, to use by the WTRU; and
receive, from the network, physical downlink shared channel (PDSCH) or transmit, to the network, physical uplink shared channel (PUSCH) using the available resources as indicated in the second indication information.

According to an embodiment, the at least one processor is configured to determine the LBT status for the available resources indicated in the first indication information based on measurements comprising any of:
an ACK-to-NACK ratio of the available resources indicated in the first indication information;
a listen-before-talk failure of the available resources indicated in the first indication information.
an interference level of the available resources indicated in the first indication information.

According to an embodiment, the at least one processor is configured to transmit, to the network, the LBT status for the at least one of the available resources indicated in the first indication information from which the WTRU receives PDSCH.

According to an embodiment, the at least one processor is configured to transmit, to the network, the LBT status for the at least one of the available resources indicated in the first indication information from which the WTRU receives at least one of:
physical downlink control channel (PDCCH);
PDSCH.

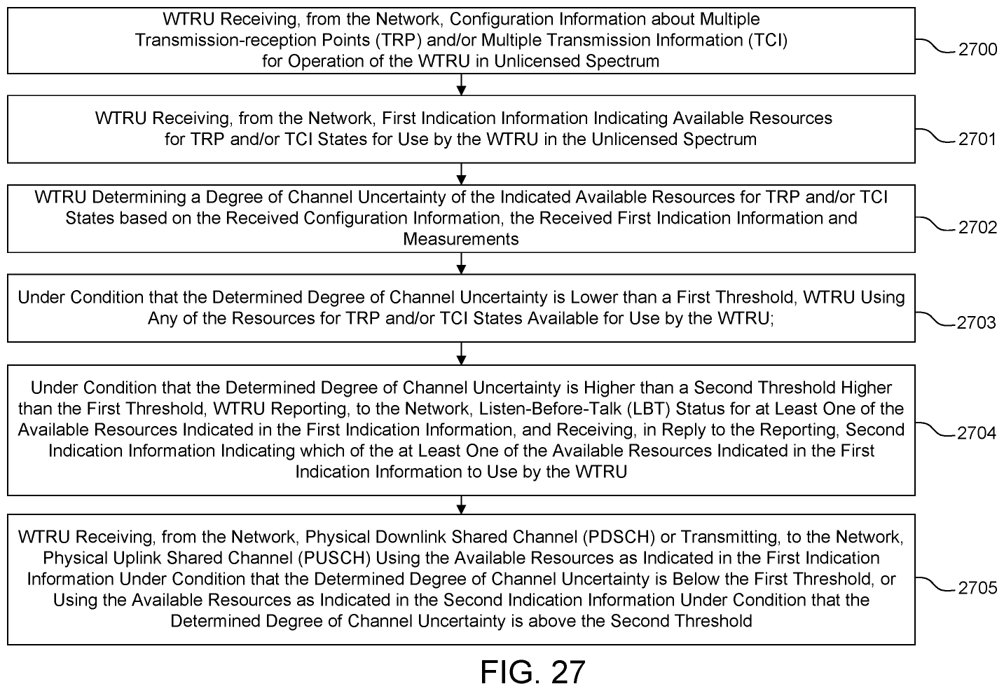

There is disclosed a method implemented by a WTRU in a network. See FIG. 27. The method comprises:
receiving (2700), from the network, configuration information about multiple transmission-reception points (TRP) and/or multiple transmission information (TCI) for operation of the WTRU in unlicensed spectrum;
receiving (2701), from the network, first indication information indicating available resources for TRP and/or TCI states for use by the WTRU in the unlicensed spectrum;
determining (2702) a degree of channel uncertainty of the indicated available resources for TRP and/or TCI states based on the received configuration information, the received first indication information and measurements;
under condition that the determined degree of channel uncertainty is lower than a first threshold, using (2703) any of the resources for TRP and/or TCI states available for use by the WTRU;
under condition that the determined degree of channel uncertainty is higher than a second threshold higher than the first threshold, reporting (2704), to the network, listen-before-talk (LBT) status for at least one of the available resources indicated in the first indication information, and receiving, in reply to the reporting, second indication information indicating which of the at least one of the available resources indicated in the first indication information to use by the WTRU; and
receiving (2705), from the network, physical downlink shared channel (PDSCH) or transmitting, to the network, physical uplink shared channel (PUSCH) using the available resources as indicated in the first indication information under condition that the determined degree of channel uncertainty is below the first threshold, or using the available resources as indicated in the second indication information under condition that the determined degree of channel uncertainty is above the second threshold.

According to an embodiment of the method, the measurements comprising any of:
an ACK-to-NACK ratio of the available resources indicated in the first indication information;
a listen-before-talk failure of the available resources indicated in the first indication information;
an interference level of the available resources indicated in the first indication information.

According to an embodiment of the method, the reporting comprises transmitting the LBT status to the network for the at least one of the available resources indicated in the first indication information from which the WTRU receives PDSCH.

According to an embodiment of the method, the reporting comprises transmitting the LBT status to the network for the at least one of the available resources indicated in the first indication information from which the WTRU receives at least one of:
physical downlink control channel (PDCCH);
PDSCH.

There is disclosed a WTRU in a network, comprising at least one processor configured to:
receive, from the network, configuration information about multiple transmission-reception points (TRP) and/or multiple transmission information (TCI) for operation of the WTRU in unlicensed spectrum;
receive, from the network, first indication information indicating available resources for TRP and/or TCI states for use by the WTRU in the unlicensed spectrum;
determine a degree of channel uncertainty of the indicated available resources for TRP and/or TCI states based on the received configuration information, the received first indication information and measurements;
under condition that the determined degree of channel uncertainty is lower than a first threshold, using any of the resources for TRP and/or TCI states available for use by the WTRU;
under condition that the determined degree of channel uncertainty is higher than a second threshold higher than the first threshold, report, to the network, listen-before-talk (LBT) status for at least one of the available resources indicated in the first indication information, and receive, in reply to the reporting, second indication information indicating which of the at least one of the available resources indicated in the first indication information to use by the WTRU; and
receive physical downlink shared channel (PDSCH) or transmit physical uplink shared channel (PUSCH) using the available resources as indicated in the first indication information under condition that the determined degree of channel uncertainty is below the first threshold, or using the available resources as indicated in the second indication information under condition that the determined degree of channel uncertainty is above the second threshold.

According to an embodiment, the at least one processor is configured to perform the measurements comprising any of:
an ACK-to-NACK ratio of the available resources indicated in the first indication information;
a listen-before-talk failure of the available resources indicated in the first indication information;
an interference level of the available resources indicated in the first indication information.

According to an embodiment, the at least one processor is configured to, as part of the reporting, transmit the LBT status to the network for the at least one of the available resources indicated in the first indication information from which the WTRU receives PDSCH.

According to an embodiment, the at least one processor is configured to, as part of the reporting, transmit the LBT status to the network for the at least one of the available resources indicated in the first indication information from which the WTRU receives at least one of:
physical downlink control channel (PDCCH);
PDSCH.

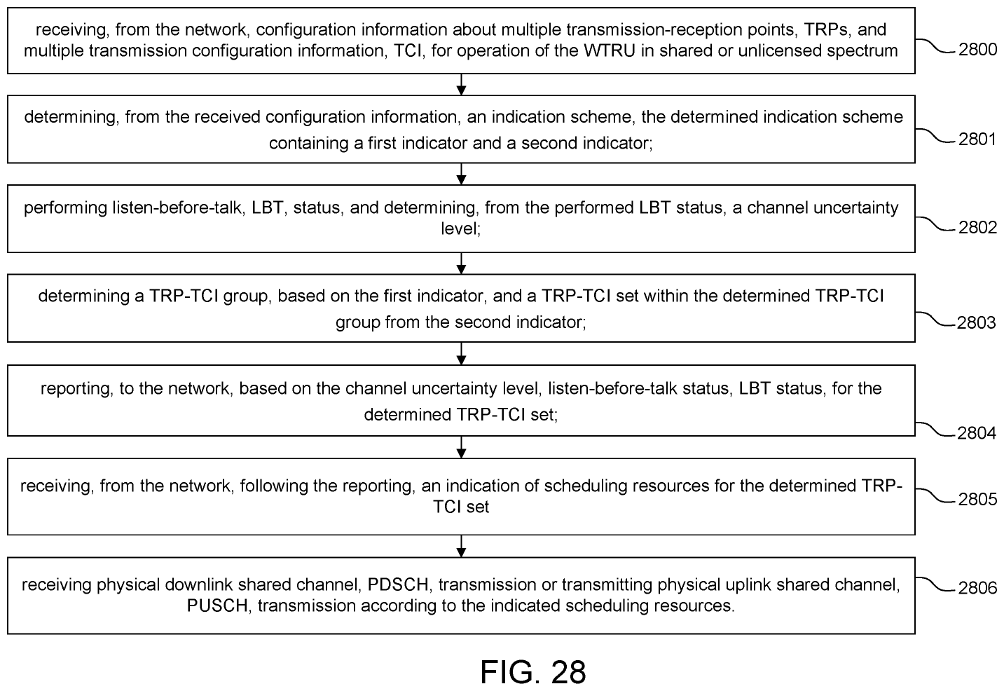

There are disclosed and described, embodiments of a method implemented by a wireless receive-transmit unit, WTRU, in a network. FIG. 28 is an embodiment of such method. The method may comprise:
receiving (2800), from the network, configuration information about multiple transmission-reception points, TRPs, and multiple transmission configuration information, TCI, for operation of the WTRU in shared or unlicensed spectrum;
determining (2801), from the received configuration information, an indication scheme, the determined indication scheme containing a first indicator and a second indicator;
performing (2802) listen-before-talk, LBT, status, and determining, from the performed LBT status, a channel uncertainty level;
determining (2803) a TRP-TCI group, based on the first indicator, and a TRP-TCI set within the determined TRP-TCI group from the second indicator;
reporting (2804), to the network, based on the channel uncertainty level, listen-before-talk status, LBT status, for the determined TRP-TCI set;
receiving (2805), from the network, following the reporting, an indication of scheduling resources for the determined TRP-TCI set; and
receiving (2806) physical downlink shared channel, PDSCH, transmission or transmitting physical uplink shared channel, PUSCH, transmission according to the indicated scheduling resources.

According to an embodiment of the method, the second indicator may indicate a TRP-TCI set of a first size and a TRP-TCI set of a second size larger than the first size, and the channel uncertainty level may determine the TRP-TCI set of the first size or the TRP-TCI set of the second size.

According to an embodiment of the method, the method may comprise selecting the TRP-TCI set of the first size for a first channel uncertainty level, and selecting the TRP-TCI set of the second size for a second channel uncertainty level higher than the first channel uncertainty level.

According to an embodiment of the method, the LBT status may be determined by performing energy detection.

According to an embodiment of the method, the LBT status may be determined based on an ACK-to-NACK ratio for the determined TRP-TCI set.

According to an embodiment of the method, the LBT status may be determined based on listen-before talk failure ratio for the determined TRP-TCI set.

According to an embodiment of the method, the LBT status may be determined based on interference level for the determined TRP-TCI set.

There are also disclosed and described, embodiments of a WTRU comprising at least one processor. The at least one processor may be configured to:
receive, from the network, configuration information about multiple transmission-reception points, TRPs, and multiple transmission configuration information, TCI, for operation of the WTRU in shared or unlicensed spectrum;
determine, from the received configuration information, an indication scheme, the determined indication scheme containing a first indicator and a second indicator;
perform listen-before-talk, LBT, status, and determine, from the performed LBT status, a channel uncertainty level;
determine a TRP-TCI group, based on the first indicator, and a TRP-TCI set within the determined TRP-TCI group from the second indicator;
transmit a report to the network, based on the channel uncertainty level, listen-before-talk status, LBT status, for the determined TRP-TCI set;
receive, from the network, following the transmission of the report, an indication of scheduling resources for the determined TRP-TCI set; and
receive physical downlink shared channel, PDSCH, transmission or transmit physical uplink shared channel, PUSCH, transmission according to the indicated scheduling resources.

According to an embodiment, the second indicator may indicate a TRP-TCI set of a first size and a TRP-TCI set of a second size larger than the first size, and the channel uncertainty level may determine the TRP-TCI set of the first size or the TRP-TCI set of the second size.

According to an embodiment of the WTRU, the at least one processor may be configured to select the TRP-TCI set of the first size for a first channel uncertainty level, and to select the TRP-TCI set of the second size for a second channel uncertainty level higher than the first channel uncertainty level.

According to an embodiment of the WTRU, the at least one processor may be configured to determine the LBT status by performing energy detection.

According to an embodiment of the WTRU, the at least one processor may be configured to determine the LBT status based on an ACK-to-NACK ratio for the determined TRP-TCI set.

According to an embodiment of the WTRU, the at least one processor may be configured to determine the LBT status based on listen-before talk failure ratio for the determined TRP-TCI set.

According to an embodiment of the WTRU, the at least one processor may be configured to determine the LBT status based on interference level for the determined TRP-TCI set.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1-14. (canceled)

15. A method implemented by a wireless receive-transmit unit (WTRU) in a network, wherein the method comprises:
receiving, from the network, configuration information about multiple transmission-reception points (TRPs) and multiple transmission configuration information (TCI), for operation of the WTRU in shared or unlicensed spectrum;
determining, from the received configuration information, an indication scheme, the determined indication scheme containing a first indicator and a second indicator;
determining a channel uncertainty level;
determining a TRP-TCI group, based on the first indicator, and a TRP-TCI set within the determined TRP-TCI group from the second indicator;
reporting, to the network, the channel uncertainty level, for the determined TRP-TCI set;
receiving, from the network, following the reporting, an indication of scheduling resources for the determined TRP-TCI set; and
receiving physical downlink shared channel (PDSCH) transmission or transmitting physical uplink shared channel (PUSCH) transmission according to the indicated scheduling resources.

16. The method of claim 15, wherein the second indicator indicates a TRP-TCI set of a first size and a TRP-TCI set of a second size larger than the first size, and wherein the channel uncertainty level determines the TRP-TCI set of the first size or the TRP-TCI set of the second size.

17. The method of claim 16, comprising selecting the TRP-TCI set of the first size for a first channel uncertainty level, and selecting the TRP-TCI set of the second size for a second channel uncertainty level higher than the first channel uncertainty level.

18. The method of claim 15, wherein channel uncertainty level is determined based on listen-before-talk (LBT) failure, or on non-acknowledge-to-acknowledge (NACK-to-ACK) ratio.

19. The method of claim 15, wherein the reporting comprises listen-before-talk (LBT) status.

20. The method of claim 19, wherein the LBT status is determined by performing energy detection.

21. The method of claim 19, wherein the LBT status is determined based on an non-acknowledge-to-acknowledge (ACK-to-NACK) ratio for the determined TRP-TCI set.

22. The method of claim 19, wherein the LBT status is determined based on LBT failure ratio for the determined TRP-TCI set.

23. The method of claim 19, wherein the LBT status is determined based on interference level for the determined TRP-TCI set.

24. A wireless receive-transmit unit (WTRU) in a network, the WTRU comprising at least one processor, wherein the at least one processor is configured to:
receive, from the network, configuration information about multiple transmission-reception points (TRPs), and multiple transmission configuration information (TCI), for operation of the WTRU in shared or unlicensed spectrum;
determine, from the received configuration information, an indication scheme, the determined indication scheme containing a first indicator and a second indicator;
determine a channel uncertainty level;
determine a TRP-TCI group, based on the first indicator, and a TRP-TCI set within the determined TRP-TCI group from the second indicator;
report the channel uncertainty level to the network, for the determined TRP-TCI set;
receive, from the network, following the reporting, an indication of scheduling resources for the determined TRP-TCI set; and
receive physical downlink shared channel (PDSCH) transmission or transmit physical uplink shared channel (PUSCH) transmission according to the indicated scheduling resources.

25. The WTRU of claim 24, wherein the second indicator indicates a TRP-TCI set of a first size and a TRP-TCI set of a second size larger than the first size, and wherein the channel uncertainty level determines the TRP-TCI set of the first size or the TRP-TCI set of the second size.

26. The WTRU of claim 25, wherein the at least one processor is configured to select the TRP-TCI set of the first size for a first channel uncertainty level, and to select the TRP-TCI set of the second size for a second channel uncertainty level higher than the first channel uncertainty level.

27. The WTRU of claim 24, wherein channel uncertainty level is determined based on listen-before-talk (LBT) failure, or on non-acknowledge-to-acknowledge (NACK-to-ACK) ratio.

28. The WTRU of claim 24, wherein the at least one processor is configured to comprise, in the report, listen-before-talk (LBT) status.

29. The WTRU of claim 28, wherein the at least one processor is configured to determine the LBT status according to at least one of:
by performing energy detection;
based on acknowledge-to-non-acknowledge (ACK-to-NACK) ratio of the determined TRP-TCI set;
based on LBT failure ratio for the determined TRP-TCI set; and
based on interference level for the determined TRP-TCI set.
